(19) United States
(12) Patent Application Publication
(10) Pub. No.: US 2011/0246911 A1
(43) Pub. Date: Oct. 6, 2011

(54) SERVER, SYSTEM, INTERACTIVE TOOL AND METHOD TO MANAGE DATA RELATED TO OBJECTS

(75) Inventor: Stanislas ZELTNER, Charleval (FR)

(73) Assignee: Qualinetwork S.A.S, Charleval (FR)

(21) Appl. No.: 12/750,779

(22) Filed: Mar. 31, 2010

(51) Int. Cl. G06F 17/30; G06F 15/173; G06F 3/01

(52) U.S. Cl. 715/760; 707/802; 707/752; 707/769; 709/223; 707/E17.005; 707/E17.014; 707/E17.044

(57) ABSTRACT

A server, system, interactive tool and method of managing data relating to objects, via a communication network, are performed by a quality management module that manages at least one quality database and controls the defining and gathering of object quality data through interaction with website managers, by controlling recording, in the quality database, of: data representing at least one evaluation of the quality of at least one object offered on the manager's website, and allowing referencing of the object by the manager in at least one category, and data representing at least one criterion to evaluate the quality of the object and the number of uses of the criterion by the managers.

### FIELD

One or more embodiments of the present invention concern the area of electronic communications, for example on networks of Internet type. One or more embodiments of the present invention more particularly concern the management (notably defining, gathering and sharing) of information relating to objects such as goods or services, for example offered on the Internet. These information relating to objects concern, in particular, their quality (or qualities) and/or their technical feature(s).

### BACKGROUND

One problem in the area of goods or services, notably those offered on the Internet, relates to the fact that an internet user surfing on websites generally only obtains a series of data referenced by the website manager and possibly concerning the characteristics of the objects, but never their quality. The quality of an object (item of goods or service) even if it refers to technical aspects of the object, is information that is complex to apprehend and difficult to gather. This problem is known in the area, but the only solutions known in the prior art generally consist of offering internet users the opportunity to give a general opinion on the object, by allocating a general rating and/or posting a comment. Only the general rating can therefore be used as an average score given to internet users, to enable them to estimate the general quality of an object, but without any definition and generally without this quality relating to any technical aspect. The only technical information which may be made available therefore generally relates to the physical characteristics defined by the providers of the goods and services.

A second problem, related to the first problem of estimating and gathering quality data, concerns the homogenization of quality criteria since quality can be a subjective notion that is difficult to rationalize in the absence of any consensus on the quality criteria to be collected. The prior art solutions do not allow quality criteria to be gathered, since they do not allow any homogenization of criteria. The sole solution of offering comments left by internet users, although possibly useful for those users who read them, does not permit an objective synthesis to be obtained since comments are scarcely easy to exploit.

A third problem related to the two first problems concerns the centralization and diffusion (sharing) of information on the quality of objects. In the prior art, there is no link between the websites, at least regarding opinions posted by internet users. Therefore the information available on one site cannot be distributed to users visiting other sites.

Furthermore, the problem of collecting information arises in regard to information relating to objects in general, and to their technical features (characteristics) in particular. For example, to build a database collecting the technical features of products and/or services, one must be able to collect and select the relevant specifications (technical features) for all categories of objects. This often requires an important degree of expertise to validate the specifications and it is thus expensive to gather all the expertises in the variety of objects that can be offered, particularly in the case of a centralization of technical features from various websites offering completely different objects one from another. The known solutions of the prior art require to manually collect technical criteria for objects and eventually the values that these criteria can take. This gathering is often not exhaustive and is generally obtained at the cost of a tedious and costly work. The sheer number of objects and their diversity are often prohibitive for the construction of a comprehensive classification.

It can therefore be appreciated that the need subsists in this area, although the drawbacks are clearly identified, for substantial resources permitting the homogenized defining of criteria relating to objects accessible via the Internet, notably concerning the technical aspects and the quality of these objects.

One last problem, which arises in this area and which would still remain with said substantial means, concerns the possible interaction by internet users with these substantial means to allow the gathering and diffusion of information on these criteria. If resources are provided allowing consensus criteria (about quality and/or technical aspects) to be defined, these criteria generally remain to be submitted to the appreciation and vote of users. This latter problem comes with problems of ergonomics, data synthesis and internet user interaction with the tools.

### SUMMARY

One purpose of the present invention is to overcome at least one of the prior art disadvantages by proposing a server to manage data relating to objects.

This purpose is achieved with a data management server relating to objects, this server, called a quality management server, being accessible via at least one communication network to at least one manager of at least one website hosted on at least one server and offering objects to internet users accessing said network via a navigator executed on their communication terminal, the quality management server being characterized in that it comprises data processing means executing at least one quality management module, managing at least one quality database also memorizing category data representing a plurality of object categories, the quality management module additionally being arranged to control the defining and gathering of data on object quality through interaction with the managers of the websites connected to the quality management server by means of a communication terminal communicating across said network, by controlling the recording in the quality database of:
evaluation data, representing a least one evaluation of the quality of at least one object offered on the manager's website, this evaluation data permitting referencing of said object by the manager in at least one category of objects of the quality database, by associating this evaluation data with category data of the quality database via the quality management module,
quality criteria data representing at least one evaluation criterion for the quality of said object and a number of uses of this criterion by managers, this quality criteria data being associated with the evaluation data, this recording of quality criteria data by the quality management module being remotely triggered by a manager, either by entry of a new quality criterion, or by selection of a quality criterion from among a list of criteria already entered by at least one manager in the quality database.

Another purpose of the present invention is to overcome at least one of the drawbacks of the prior art by proposing a system to manage data relating to objects.

This purpose is achieved with a system to manage data relating to object quality, via at least one communication network, comprising at least one server of a manager of at least one website offering objects to internet users having access to said network via a navigator executed on their communication terminal, characterized in that it comprises at least one communication terminal of at least one website manager and at least one quality management server according to the invention.

A further purpose of the invention is to overcome at least one of the shortcomings of the prior art by proposing an interactive tool for the management of data relating to objects.

This purpose is achieved via an interactive tool for collaboration between internet users on the management of data relating to objects via at least one communication network, the interactive tool being arranged to be executed in the navigator of at least one communication network of at least one internet user, and characterized in that it forms a graphic interaction interface for the internet user directly with the quality management module of a management server according to the invention, by means of at least one link displayed on this interface that can be selected by the internet user and is directed towards at least one function of this quality management module.

A further purpose of the present invention is to overcome at least one of the drawbacks of the prior art by proposing a method for the management of information on objects.

This purpose is achieved with a method to manage data relating to objects, on at least one server called quality management server, accessible via at least one communication network to at least one manager of at least one website hosted on at least one server and offering objects to internet users having accessing to said network via a navigator run on their communication terminal, the method being characterized in that the quality management server comprises data processing means executing at least one quality management module, managing at least one quality database and additionally memorizing data representing a plurality of object categories, the quality management module further being arranged to manage interaction with the managers of websites connected to the quality management server by means of a terminal communicating across said network, to control the defining and gathering of data on object quality by implementing the following steps:
recording evaluation data in the quality database, representing at least one evaluation of the quality of at least one object offered on the manager's website, this evaluation data comprising data representing the referencing of said object by the administrator in at least one object category of the quality database,
recording quality criteria data in the quality database, representing at least one quality criterion for said object and a number of uses of this criterion by managers, this recording of quality criteria data by the quality management module being remotely triggered by a manager, either by means of a step to enter a new quality criterion, or a step to select a quality criterion from a list criteria already entered in the quality database by at least one manager.

### BRIEF DESCRIPTION OF THE DRAWINGS

Other aspects and advantages of the present invention will become more clearly apparent on reading the following description, given with reference to the appended drawings, in which:

FIG. 1 is a schematic illustration of one embodiment of a system for managing data relating to objects, notably their quality;

FIG. 2 is a schematic illustration of one embodiment of some steps of a method to manage data relating to objects, notably their quality;

FIG. 3 is a schematic illustration of one embodiment of some steps of a method to manage data relating to objects, notably their quality;

FIG. 4 is a schematic view of one embodiment of some steps of a method to manage data relating to objects, notably their quality;

FIG. 5 is a schematic view of one embodiment of some steps of a method to manage data relating to objects, notably their quality;

FIG. 6 is a schematic view of one embodiment of some steps of a method to manage data relating to objects, notably their quality;

FIG. 7 is an illustration of an exemplary criterion thumbnail evaluation form;

FIG. 8 is an illustration of an exemplary language tag used in a website source code;

FIG. 9 is an illustration of an exemplary tag in an integration method provided for managers;,

FIGS. 10-15 are illustrations of display screens with differing representations of quality voting; and

FIG. 16 is an exemplary illustration of a display of statistical data.

### DETAILED DESCRIPTION OF THE DRAWINGS

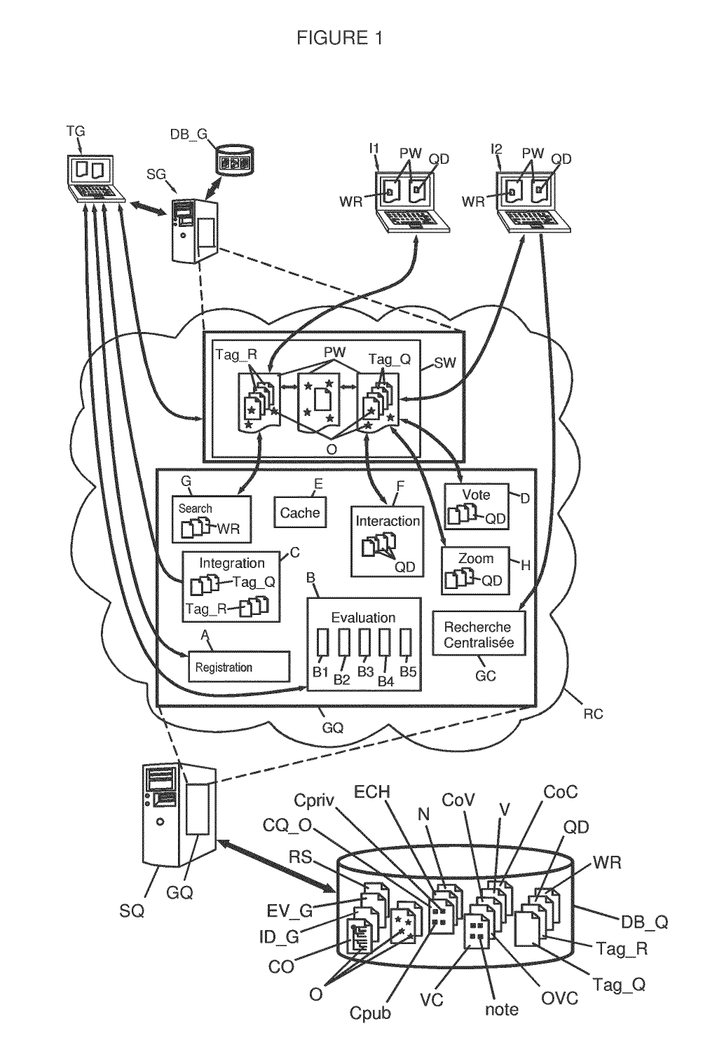

The present invention concerns at least a server, a system, an interactive tool and a method to manage data relating to objects, notably to object quality. The present description refers mainly to data relating to objects' quality but it will appear, after appreciating the disclosure, that the invention is not limited to quality although it is particularly advantageous for this type of information because it allows to rationalize them. The server for the management of data on object, called quality management server (SQ), according to one embodiment of the invention, is illustrated in FIG. 1 within a system according to one embodiment of the invention, in which firstly a server (SG) of a website manager hosts a website (SW) containing web pages (PW) offering objects (O) to internet users, a communication terminal (TG) of the manager communicates with the quality management server (SQ) to define data on the quality of objects (O), and communication terminals (I1, I2) of internet users access the manager's website (SW) and use interactive tools (QD, WR) therein, according to various embodiments of the invention, to interact with the quality management server (SQ).

The quality management server (SQ) is accessible via at least one communication network (RC), for example a network of Internet type. The managers preferably access the quality management module (GQ) via at least one communication terminal (TG), such as a computer connected to the internet for example, but they may possibly have access thereto directly from a server (SG) of the manager. The expression “communication terminal” is not limiting and may concern any type of equipment enabling its user to communicate via the Internet. No detail is necessary nor will be given here on the network and the resources forming communication terminals and servers, with the exception of the specific modules and tools for implementing the invention. In fact, it is known to the person skilled in the art that these terminals and servers comprise for example data processing resources (with at least one processor) running an operating system in which various applications can be executed. For example, the communication terminals (I1, I2, TG) run a “browser” (or navigator) allowing navigation on the network (RC) and consulting of websites. The servers execute at least one application allowing the hosting of at least one website and offering internet users the possibility to consult the various pages of the website by interaction, via their communication terminal, through page consultation, selection and entry within these pages. Similarly, the display resources and selection or entry resources of the communication terminals (I1, I2), TG) and/or of the servers (SG, SQ) are known and are not detailed herein. The manager's server (SG) can, in some embodiments, comprise or be associated with at least one database (DB_G) storing the data required for at least one website (SW) of the manager.

By the term “manager” is meant herein any person or group of persons responsible for or authorized to manage a website. For example, this may be a “webmaster” who manages the site data in general, and in particular the integration of the operating functions of the present invention, as explained in the present application. By the term “internet user” is meant any person who navigates on the network (RC) via their communication terminal. FIG. 1 shows a first communication terminal (I1) of an internet user consulting the website (SW) of a manager and accessing web pages (PW) permitting interaction with a search tool (WR) as explained herein. FIG. 1 also shows a second communication terminal I2 of an internet user (the same or another) who consults the website (SW) of a manager and accesses web pages permitting interaction with at least one voting tool (QD) as explained in this application, and also directly accessing the quality management server (SQ) to carry out a centralized search as explained in the present application. The terms web page (PW) or internet site or website (SW) may be indifferently used herein (these terms being conventionally used in this area).

The quality management server (SQ) is accessible to the managers for example via a website hosted by the quality management server (SQ). A quality management module (GQ) run on this server is also arranged, among other things, to control the defining and gathering of data on object quality by means of interaction with the managers of the websites (SW) connected to the quality management server (SQ) via a communication terminal (TG, SG) communicating across said network (RC). The quality management module (GQ) is also arranged to control the interaction with internet users consulting the web pages (PW) of a website (SW) of a manager registered with the quality management server (SQ). This interaction is made directly between the internet user's communication terminal (I1, I2) and the quality management module (GQ) through interactive tools (QD, WR), via the web pages (PW) hosted by the manager's server (SG), as detailed in the present application. In some embodiments, these interactive tools may be of graphical interface type known as “widgets” (contraction of “windows” and “gadget”). These tools run on the navigators of terminals in a page hosted by a first server, permit interaction by the internet user (via displays and selections/entries made by internet users on their terminals) with a second server. Therefore, these tools enable data to be obtained from the second server whilst remaining on the page hosted by the first server.

For interaction with the managers, in some embodiments, the quality management module (GQ) may comprise at least one function similar or identical to a website management application and provide the required web pages through action taken by managers connected thereto. In other embodiments, the quality management module (GQ) may be arranged for managing the interaction of managers via interactive tools, as described in the present application for interaction with internet users. FIG. 1 therefore illustrates a quality management module (GQ) managing interactions with the managers' (TG, SG) and internet users' (I1, I2) terminals. The quality management server comprises (or is associated with) at least one quality database (DB_Q) storing various types of data required for implementing the invention. It is to be noted that by the terms “server” and “terminal” as used herein is meant “at least one server” and “at least one terminal”, notably with respect to servers whose complicated functions may sometimes physically require the contribution of several devices which in fact form a single functional entity. Reference is therefore made herein to this functional entity. Similarly, the quality management module (GQ) is a functional entity implemented in the form of at least one application executed on at least one quality management server (SQ). FIG. 1 shows the quality management module (GQ) comprising a plurality of other modules (A, B, C, D, E, F, G, H and GC), even sub-modules (B1-5). The present description details the functions carried out by these different modules and sub-modules separately, of which at least part may correspond to at least one application on a dedicated server accessing at least part of the quality database (DB_Q), such as, for example, in the embodiments comprising functions of the cache module (E). The quality management module (GQ) may be a module controlling the inter-operability of the other modules (A, B, C, D, E, F, G, H and GC) and sub-modules, or itself executing all or part of the functions of these modules (A, B, C, D, E, F, G, H and GC) or sub-modules described in the present application. In general, the functions may be implemented in at least one module (functional entity, for example implemented in the form of at least one application executed on at least one server). The invention provides for any combination of functions of the modules described in the present application. Some embodiments are arranged to comprise all these functions, and other embodiments may only comprise part thereof. For example, the modules (A, B, C) for interaction by the managers can be isolated from the modules (D, E, F, G, H and GC) for interaction by internet users. In some embodiments, the quality management module (GQ) is arranged for interaction by internet users, notably using interactive tools, irrespective of the fact that the data (detailed in the present invention) on the quality of objects (O) has or has not been generated as described in the present application by at least one evaluation module (B), provided that the quality database (DB_Q) contains the data needed for the interactive tools (QD, WR), although exploitation of the number (N) of uses of criteria allows convergence of criteria towards the most consensual and allows the internet users to then interact on the most pertinent criteria. At least one server which only executes modules for interaction with the interactive tools may therefore come within the scope of the invention, notably may it have or not criteria data sorted in relation to the number (N) of uses by managers as detailed in the present application.

Similarly, the invention also concerns a system to manage data on object quality. Various embodiments of this system may comprise any embodiment of the quality management server (SQ), i.e. a quality management server comprising at least one module (at least GQ, and/or B, and optionally A and/or C) for interactive management with managers and/or comprising modules (at least GQ, and/or F and optionally D and/or G and/or E and/or H and/or GC) for interactive management with internet users. For example, some embodiments concern a system to manage data on object quality via at least one communication network (RC), comprising at least one server (SG) of a manager of at least one website (SW) offering objects (O) to internet users accessing said network (RC) via a navigator run on their communication terminal (I1, I2), characterized in that it comprises at least one communication terminal (TG, SG) of at least one manager of a website (SW) and at least one quality management server (SQ) according to the invention. In some embodiments, the system comprises at least one communication terminal (I1, I2) of at least one internet user, and at least one quality management server (SQ) according to the invention, notably with functions for interaction by internet users.

Similarly, the invention also concerns at least one interactive tool for collaboration of internet users in the management of data on object quality. Various embodiments of interactive tool may cooperate with any embodiment of the quality management server (SQ), irrespective of whether the data (detailed in the present application) on the quality of objects (O) has or has not been generated as described in the present application by at least the evaluation module (B) (notably irrespective of the exploitation of the number (N) of uses of criteria, even though this number (N) permits convergence of criteria towards the most consensual, and internet users then interact on the most relevant criteria), provided that the quality database (DB_Q) comprises the data needed for the interactive tools (QD, WR). These various embodiments of interactive tool may require at least one integration module (C) to integrate a tag (Tag_Q, Tag_R), in at least one web page (PW) of a website (SW) allowing execution of the tool on the navigators accessing this page, and at least one interaction module (F) in the quality management server (SQ) to manager interaction with the internet user by means of the functions implemented in the tool.

Various types of data organization in the databases (DB_Q, DB_G) are possible and mention will simply be made, as a non-limiting and illustrative example, of data organized in the forms of tables of n-tuples which are ordered collections of n components. The present application describes the creation, recording, consultation, etc. of various types of data which are designated, in a non-limiting manner, as per the type of information they represent. Additionally, the present application describes associations between different types of data. Indeed, the databases allow the adding of links between different sets of data. For example, at least one value (one component) of a first type (n-tuple) of data can be associated with at least one value (one component) of a second type (n-tuple) of data. No detail is needed nor will be given in this application on the manner in which the associations (relationships, links) between data are added. Also, the databases can be stored on memory resources such as at least one hard disk for example. The databases can also be stored on various memory resources located together or distributed over at least one communication network (RC) for example. In general, it is considered here that the servers access these databases whether the memory resources are directly in the server or whether they are accessible via any type of link. In some embodiments, notably those implementing cache functions, the data of the cache files are preferably stored on different memory means to those storing the quality database (DB_Q).

The invention uses links on the web pages but also on the interactive tools, and selection and/or entry fields according to various types known in this area, such as for example “hypertext” links on web pages which redirect to another web page, or function links such as buttons to instantiate a module or software application executed for example within a software environment provided by the navigator (such as the interactive tools in the present invention for example). Similarly, entry fields are known for example in which internet users enter text data, and selection fields in which internet users make selections (for example scroll menus, or boxes to be ticked, or virtual selection or validation buttons, etc.). All these types of links can be represented by a button and/or icon and/or text. In some cases, the links may substitute for selection fields or even entry fields (provided the necessary information is displayed next to these) or conversely. The use of these various terms in the present application is therefore not limiting with respect to the function associated therewith.

Also, the present application describes forms. At least part of each of these forms can be stored in the quality database (DB_Q), for example regularly re-updated in relation to changes to other data in the quality database (DB_Q), and at least part may be prepared as and when the need arises.

Finally, the invention makes provision for extensive caching of functions of the quality management server, to meet high demand (notably for access to the database).

The quality management server (SQ) is accessible via at least one communication network (RC) to at least one manager of at least one website (SW) hosted on at least one server (SG) and offering objects (O) to internet users having access to said network (RC) via a navigator run on their communication terminal (I1, I2). This quality management server (SQ) comprises data processing resources executing at least one quality management module (GQ) managing at least one quality database (DB_Q) also memorizing category data (CO) representing a plurality of categories of objects (O). This quality management module (GQ) is also arranged to control the defining and gathering of data on object quality by means of interaction with the managers of websites (SW) connected to the quality management server (SQ) via a communication terminal (TG, SG) communicating across said network (RC). For this purpose, the quality management module (GQ) manages interaction with the managers, and in relation to actions taken (selection/entry in various fields of the web pages (or interactive tools) transmitted to managers), controls the recording in the quality database (DB_Q) of evaluation data (EV_G) and of quality criteria data (CQ_O). The evaluation data represent at least one evaluation of the quality of at least one object (O) offered on the manager's website (SW). This evaluation data (EV_G) at least allows the referencing of the object (O) by the manager in at least one object category (CO) of the quality database (DB_Q), by the association of this evaluation data (EV_G) with the category data (CO) in the quality database (DB_Q) by the quality management module (GQ). The quality criteria data (CQ_O) represent at least one evaluation criterion of the quality of said object (O) and a number (N) of uses of this criterion by the managers. These quality criteria data (CQ_O) are preferably associated with the evaluation data (EV_G). In some embodiments, this recording of quality criteria data (CQ_O) by the quality management module (GQ) is remotely triggered by a manager, either by means of entry of a new quality criterion, or by means of selection of a quality criterion from a list of criteria already entered by at least one manager into the quality database (DB_Q).

It is therefore appreciated that data defining and gathering is made remotely and in a collaborative manner. The managers are remotely connected to the server (SQ) which enables them to enter data into the quality database. The server also enables them to define, in a collaborative manner (several managers can each make their own contribution) the data used to define object quality.

Interaction with the managers, in some embodiments, takes place via web pages which the quality management module (GQ) sends to the navigator of the managers' terminals (TG, SG). These pages comprise various information on the steps to be followed and contain entry fields and/or selection fields (e.g. scroll menus) and links or functions which can be selected (e.g. by validation buttons) to enable managers to interact with the management module thanks to a terminal (TG or SG) connected through the network (RC).

In some embodiments, the management module (GQ) is arranged to save in the database, in (or in association with) object category data (CO), technical criteria (CT) data representing technical features of objects (O) of a given category (CO). In fact, the objects (O) offered by the managers on the website (SW) are often listed with a plurality of technical features (characteristics). The quality management module can therefore also record at least part of these technical characteristics, for example in association with the category data. Therefore, when a manager selects a category, the technical characteristics which may concern the object in the progress of being evaluated can be found directly. In some embodiments, the management module (GQ) is arranged to offer managers new quality criteria (when none exist or even if some already exist) on the basis of these technical criteria (CT) data representing technical characteristics of objects (O) in a given category (CO). In this way, managers are guided in their choice of quality criterion to define these criteria with reference to the technical characteristics of the objects. Convergence of criteria on the technical aspects of objects is therefore more easily obtained, which will subsequently be more easily the subject of consensus among managers. The invention also proposes advantageous mechanisms for managing these technical criteria (CT) data, similarly to those described for quality criteria.

In some embodiments, the quality management module (GQ) is arranged to allow search for criteria via keywords, in the quality criteria data (CQ_O). In general, search by keyword is possible in any type of data in the quality database (DB_Q). In some embodiments, the quality management module (GQ) is arranged to allow search for criteria through the number (N) of uses of these criteria in the quality criteria data (CQ_O).

In some particularly advantageous embodiments, the quality management module (GQ) is arranged to sort the quality criteria (CQ_O) of a given object category (CO) in relation to the number (N) of their uses by the managers, and to present the managers with this list of sorted criteria at the time a manager records criteria. This use of the number (N) of uses of criteria permits (or facilitates) convergence of criteria used towards the most consensual criteria. The list of criteria presented to the managers may for example be limited to a restricted number of the most used criteria (for a given category for example). The quality management module (GQ) (or evaluation module B) is then arranged to present a list of criteria already used by registered managers, sorted in relation to the number (N) of their uses (or “popularity”) among managers by means of a criterion sorting algorithm. In some embodiments, detailed in the present application, the criteria are differentiated as per the fact that they have been used by only one manager (so-called “private” (Cpriv) criteria) and are only associated with this manager, or that they have been used by several managers (so-called “public” or “shared” (Cpub) criteria) and are associated with a category of objects. This criterion sorting algorithm then makes it possible to consult the database to obtain criteria available for the category by consulting the criteria data (CQ_O) associated with category data (CO) if criteria exist in this category (Cpub), or in the criteria data (CQ_O) associated with the evaluation data (EV_G) if no criteria exist in this category (or only a private criterion which is only associated with the evaluation data and not the category data). The number (N) of uses and notably the presentation sorted as per this number permits classification of criteria according to their popularity (e.g. in decreasing order). Therefore the most used criteria to qualify an object in a category are preferably presented to managers creating an evaluation of an object in the same category, and the different criteria proposed by the different managers therefore converge towards consensual criteria as and when criteria are used by the managers. The presented list of criteria may be limited to a determined number of criteria (e.g. only the 5 or 10 most used criteria are presented). However, the invention makes provision for the adding of new criteria and the presentation of recent criteria. The presentation of recent criteria will facilitate their re-use and their rise up through the list of the most popular criteria.

The invention also concerns a method for the management of data relating to object, on at least one quality management server (SQ). This quality management server (SQ) controls the defining and gathering of data on object quality by implementing the:
recording (60) evaluation data (EV_G) in the quality database (DB_Q), representing at least one evaluation of the quality of at least one object (O) offered on the manager's website (SW), this evaluation data (EV_G) comprising data representing the referencing of said object (O) by the manager in at least one category (CO) of objects in the quality database (DB_Q),
recording (61) quality criteria data (CQ_O) in the quality database (DB_Q), representing at least one evaluation criterion for the quality of said object (O) and a number (N) of uses of this criterion by the managers, this recording of quality criteria data (CQ_O) by the quality management module (GQ) being remotely triggered by a manager, either by means of an entry (6019) of a new quality criterion, or by means of a selection (6024) of a quality criterion from a list of criteria already entered by at least one manager into the quality database (DB_Q).

In some embodiments, the recording (61) of quality criteria data (CQ_O), if quality criteria data (DB_Q) already exist for the object category (CO) selected by the manager, is preceded by a sorting (6110) of the quality criteria (CQ_O) associated with this category (CO), to sort the criteria in relation to the number (N) of their uses by the managers, and a display (6026) for displaying the list of sorted criteria to allow convergence of used criteria towards the most consensual criteria.

In some embodiments of the quality management server (SQ), the management module (GQ) is arranged to identify managers registered with the quality management server (SQ), by means of identification data (ID_G) representing at least one manager identifier, stored in the quality database (DB_Q). In some embodiments, the evaluation data (EV_G), representing at least one evaluation of the quality of at least one object (O), is recorded by the quality management module (GQ) in association with these identification data (ID_G). Identification is preferably made by a registration module (A) such as shown in FIG. 1. The manager accesses a web page dedicated for example to the management of accounts, which instantiates the registration module (A) managing all identification data (ID_G).

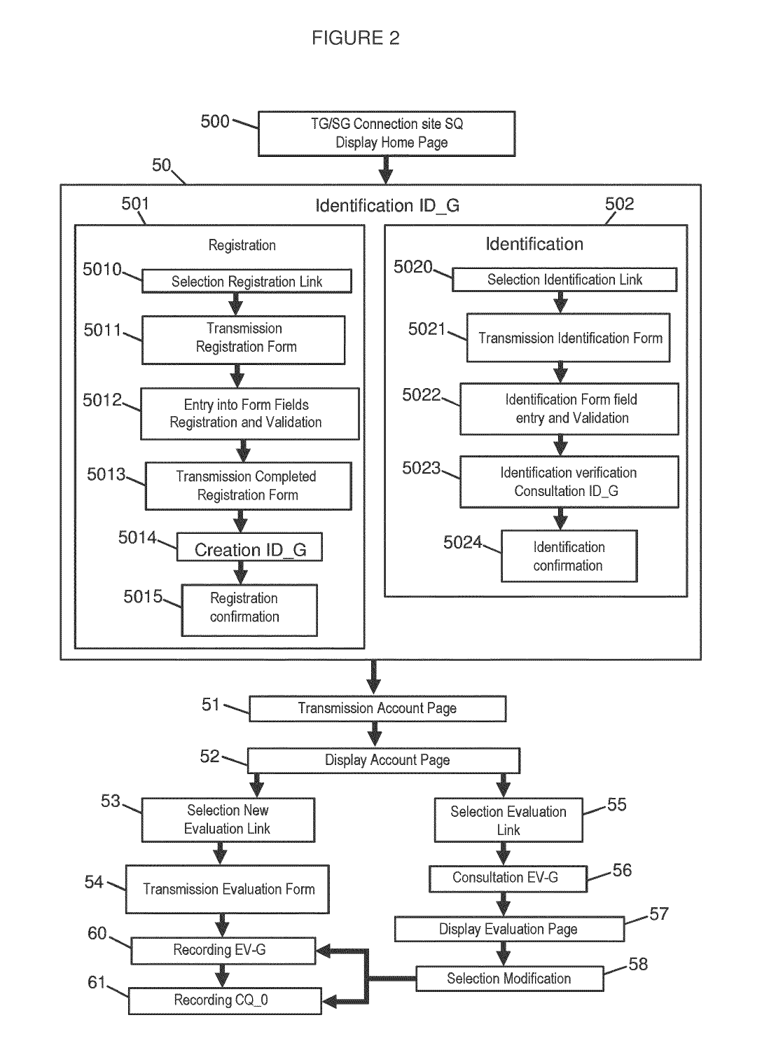

Some embodiments of the method therefore comprise an identification (50) to identify managers registered with the quality management server (SQ) using the identification data (ID_G) representing at least one identifier of a manager, stored in the quality database (DB_Q). In some embodiments, the recording (60), by the quality management module (GQ), of evaluation data (EV_G) representing at least one evaluation of the quality of at least one object (O), is accompanied by a recording (6040) of data representing an association of these evaluation data (EV_G) with the manager's identification data (ID_G). FIG. 2 illustrates one embodiment of the method, giving details of an identification step either of a non-registered manager who registers for the first time (Registration Form) or by a manager already registered (Identification Form). In this embodiment, a connection (500) of the manager's terminal (TG, SG) to the quality management server (SQ) allows the display of a home page. During the identification (50), a manager who wishes to register (create an account) selects (5010) a registration link in the page displayed on his terminal. The registration module (A) (or the quality management module GQ in general as mentioned above) then transmits (5011) a registration form. The entry (5012) by the manager of required information into the data entry fields of the form, followed by validation, permits transmission (5013) of the completed form towards the registration module which creates (5014) identification data (ID_G) in the quality database (DB_Q), and optionally returns (5015) confirmation of registration.

During the identification (50), a manager already registered (having an account) who wishes to identify himself, selects (5020) an identification link in the page displayed on his terminal. The registration module (A) transmits (5021) an identification form. The entry by the manager (5022) of the required information into the data entry fields of the form, followed by validation, then permits transmission (5023) of the completed form towards the registration module which consults the identification data (ID_G) in the quality database (DB_Q), and optionally returns (5024) confirmation of identification, or an error message if data entry is incorrect or does not correspond to any identification data (ID_G).

It will be noted that by the term “entry”, for example in a form, it is meant herein that this term also covers any type of selections (for example through scroll menus, boxes to be ticked, etc.) in addition to entry of actual text. The term <<selection>> may be used in a general manner for designating the validation of a choice by the users (managers or internet users), may i actually be a selection or an entry.

Subsequent to identification, the quality management module (GQ) (or registration module A) transmits (51) a page to the manager containing information on his account, for example, and links to the various operating functions of the quality management server (SQ). For example, the manager may, subsequent to the display (52) of this “account” page, select (53) a link to create a new evaluation of an object so that the quality management module (GQ) (or so as to instantiate the evaluation module B, which) transmits (54) an evaluation form allowing access to the recording (60) of evaluation data (EV_G) and/or saving (61) of category data (CQ_O). Similarly, the manager may for example, subsequent to the display (52) of this page, select (55) an “evaluation” link in the “account” page so that the quality management module (GQ) (or so as to instantiate the evaluation module B which) consults the manager's evaluation data (EV_G) and transmits to the manager the necessary data for display (57) of a page containing his evaluations. The manager may then consult and/or modify the evaluations he has entered into the quality database (DB_Q). The selection (58) of a modification link gives access to the entering (60) of evaluation data (EV_G) and/or the entering (61) of category data (CQ_O).

In general, irrespective of the web page or tool used by the manager, the method may comprise a selection step (6050) to select at least one evaluation link giving access to at least one form to record at least one evaluation, with the evaluation data (EV_G) and notably the category (CO) and/or criteria data (CQ_O). A selection (6050) of an “evaluation” link by the manager (on a web page hosted by the quality server (SQ) or on an interactive tool) can trigger the functions for the recording (60) of evaluation data. In some embodiments, the recording of evaluation data (EV_G) and of quality criteria data (CQ_O) is preferably made by an evaluation module (B) as illustrated in FIG. 1. In some embodiments, the evaluation module (B) comprises several sub-modules, each managing part of the data recorded during interaction with the manager. For example, provision may be made for a sub-module for each type of configurable data in an evaluation. For example a “general” sub-module (B1) can be used to save general information on the evaluation (name, website, description, etc.). A “theme” sub-module (B2) can be used to save information on presentation of the evaluation, i.e. data presentation modes, notably of summary representation type (RS) to be used in the interactive tools and representing votes, as described in the present application. A “category” sub-module (B3) can be used to enter information on the category of the object concerned by the evaluation. A “criterion” sub-module (B4) can be used to define evaluation criteria and the recording of quality criteria data (CQ_O). A “parameter” sub-module (B5) can be used to enter information on evaluation parameters, e.g. parameters regarding activation of evaluation, the referencing of evaluation in a search module of the management server, display of the manager's logo on the interactive tools, voting scenarios (on-line on an interactive tool or by email), the posting of comments by internet users when voting, etc.).

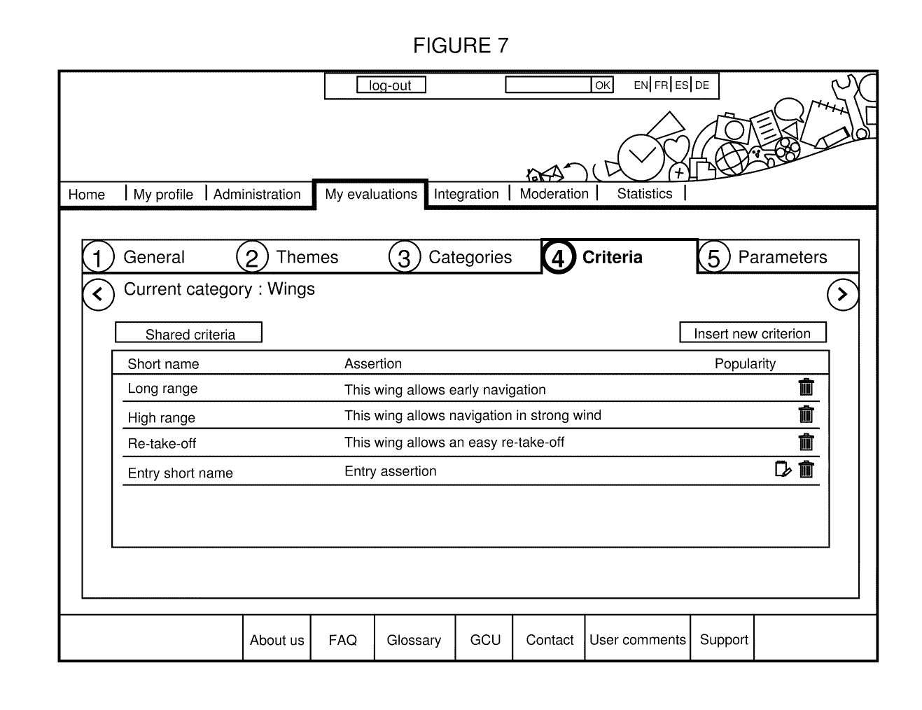

In manner known per se, the forms can be of varied types and of greater or lesser complexity, such as several thumbnails or several links rolling out fields for the various available definitions (general, theme, category, criterion, parameters). One example of an evaluation form under the “criterion” thumbnail is illustrated in FIG. 7 hereto. The data created dynamically through interaction of the manager with the form can be created when the form is sent back or on each change or validation of a thumbnail or link. Various mechanisms within the reach of the person skilled in the art are possible for this presentation of information and for this interaction with managers. It is possible for example to provide a single complete form for all the definitions required by all the evaluation sub-modules (B1 to B5). Therefore, selections of links by a manager, in the present application, are defined as triggering the transmission of forms, but it will be appreciated that the form transmission steps can be omitted if the necessary data has already been transmitted during a previous step (for example at the same time as the data enabling display of the selected link), or they may be replaced by transmission solely of data required for page display of a form already partly loaded by the navigator. Numerous variations are within the reach of the skilled person and the details given in the present application about the transmission and validation of forms or links or selections are not limitative.

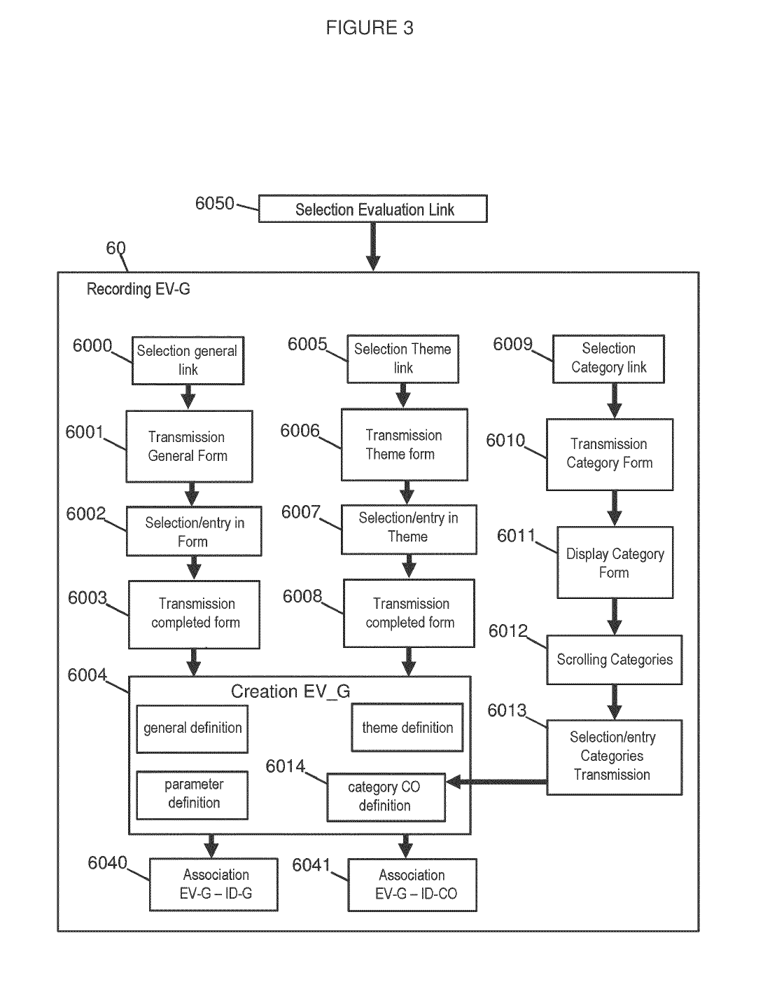

FIG. 3 illustrates one embodiment of the recording (60) of evaluation data. This recording (60) at least allows defining (6014) of the category (CO) to which belongs the object (O) that is in the progress of evaluation. In the embodiments in which the evaluation form allows the defining of a plurality of data (e.g. general, theme, category, criterion, parameter as described above), the selection (6009) of a “category” link can instantiate the quality management module (GQ) (for example by means of an evaluation module B or category sub-module B3) for transmission (6010) of a “category” form (or category data for display in a form already loaded by the navigator) and the display (6011) of this form, enabling the manager to scroll (6012) through the categories. The object categories generally organized in families with infinite sub-categories (the manager is able to create a new category if none is found suitable for the object for which it is desired to define an evaluation). The selection/entry (6013) of a category permits transmission to the quality management server (SQ) for recording of the evaluation data (EV_G). If no evaluation data currently exist for this object, this recording operation gives rise to a creation step (6004) of evaluation data (EV_G) in the quality database (DB_Q). The method may then also comprise an association (6040) of the evaluation data (EV_G) with the manager's identification data (ID_G) so that evaluation is recorded as relating to an object proposed by a determined manager in the quality database (DB_Q). The method may also comprise an association (6041) of the evaluation data (EV_G) with category data (CO), so that the evaluation can be recorded as concerning an object in a given category of the quality database (DB_Q).

For the defining of general evaluation data, the manager may select (6000) a “general” link for example giving rise to the transmission (6001) of a general form by the quality management module (GQ) (for example via an evaluation module B or general sub-module B1). The selection/entry (6002) in the form, followed by its validation then allows transmission (6003) of the completed form and the updating, or creation (6004) if none exist, of the evaluation data (EV_G). Similarly, to define the theme of evaluation, the manager may select (6005) a “theme” link for example permitting the transmission (6006) of a theme form by the quality management module (GQ) (for example via an evaluation module B or theme sub-module B1). Selection/entry (6007) in the form followed by its validation then permits the transmission (6008) of the completed form and the updating, or creation, (6004) if none exist, of the evaluation data (EV_G). Similar functions or steps are possible for the general parameters or any additional type of information.

As mentioned previously, the recording of quality criteria (CQ_O) in the database allows the manager to define criteria, notably regarding the technical aspects of the object, to enable internet users to give their opinion on these criteria and thereby obtain the most relevant evaluation possible of the quality of the object. Under the present invention, the problem of quality is formulated using criteria. The mechanisms implemented for this formulation and for the gathering (and sorting/selection) of used criteria allow to obtain objective criteria for assessing (evaluating) the quality of an object. Thus, the invention allows to organize a quality database (DB_Q) with usable data for retrieval of objects based on data which are concrete and automatically selected for their relevance. The invention facilitates the definition, centralized collection and use of relevant information in the assessment of objects, especially on their quality and technical features, and can provide a particularly effective search engine. A criterion preferably comprises a short name and an assertion. For example, the manager defines a short name such as “autonomy” (relating to the technical characteristic of operating time) and an assertion such as “This device has good autonomy”. These criteria can then be used by internet users to give their opinion on a scale (ECH) of several values, for example 5 scores: “fully disagree”, “disagree”, “more or less agree”, “agree”, “fully agree” (or “very good”, “good”, “fair”, “poor”, “very poor”, etc.). In relation to the theme chosen by the manager, these scores can be represented by various kinds of depictions such as colours or other symbolic forms (histograms, stars, smileys, radars, etc.). FIG. 7 gives an example of criteria for kitesurf or flysurf wings.

In some embodiments, the management module (GQ) is arranged for managing the recording, in the database, of quality criteria data (CQ_O) representing a criterion for the evaluation of the quality of an object (O), in association with at least part of the manager's identification data (ID_G) and/or evaluation data (EV_G). This association keeps track of the use of a given criterion by a given manager. For example, when creating a criterion, data on the criterion's author's can be recorded (e.g., a name and/or an avatar and/or a pseudo of the manager). In some embodiments, when a manager enters a new criterion, the management module (GQ) generates quality criterion data (CQ_O) and associates them with at least part of manager identification data (ID_G) and/or evaluation data (EV_G). In contrast, when a manager selects an existing criterion which is proposed by the management module (GQ), the latter may generate only data representing an association of data quality criteria (CQ_O) to at least part of manager identification data (ID_G) and/or evaluation data (EV_G). However, in some embodiments, the quality criteria are distinguished as per that they have been used by a single manager or by several, for example by generating new criterion data (CQ_O) each time a criterion is reused by a manager while he had only been used by a single manager until then. In these embodiments, when a manager selects an existing criterion, the management module (GQ) can generate again data quality criterion (CQ_O) and associate them to at least a portion of Manager Identification data (ID_G) and/or evaluation data (EV_G), as detailed below. Therefore in some embodiments of the method, at the time a criterion is entered (61) by a manager, the quality management module (GQ) implements a creation (6100) of data, in the quality database (DB_Q), representing at least an association of quality criteria data (CQ_O) with at least part of the manager's identification data (ID_G) and/or evaluation data (EV_G). When creating a new quality criterion (which isn't therefore represented by any data yet), the Quality Management module (GQ) implements a creation (6100) of data (CQ_O) representative of this quality criterion and of data representative of their association with at least a portion of identification data (ID_G) manager and/or evaluation data (EV_G).

In some embodiments particularly advantageous for the automatic selection of the most relevant criteria, the Quality Management module (GQ) is arranged to increment the number (N) of use of the criterion, upon recording of a quality criterion. In related embodiments of the method, the creation (6100) is accompanied by an incrementation (6104) of the number (N).

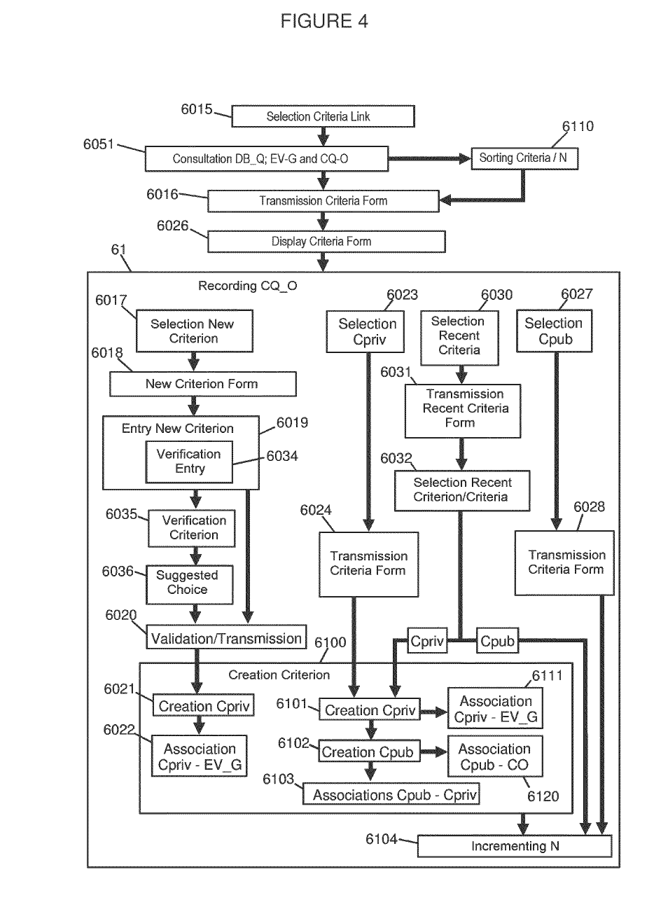

The recording (61) of criteria can be preceded by a criteria sorting step (6110) as mentioned previously. To do so, the quality management module (GQ) (for example via an evaluation module B or criterion sub-module B4) is arranged to consult the quality database (DB_Q), and notably the evaluation data and/or criteria data (CQ_O) to determine a list of available criteria, then to sort this list in relation to the number (N) of uses of these criteria, preferably in decreasing order. The recording (61) and sorting (6110) are therefore preceded by a database consultation (6051). This sorting allows the transmission (6016) of a criteria form to the manager and its display (6026), in this case with presentation of the list of sorted criteria. These functions or steps can be implemented upon a selection (6015) of a “criteria” link by the manager, as illustrated in FIG. 4. For example, an evaluation form such as the one in FIG. 7 contains a “criteria” thumbnail which can be selected and permit at least the display (6026) (the consultation, sorting and transmission possibly having been previously conducted).

In the “criteria” form, the manager can create at least one new criterion and/or select at least one existing criterion (for example in at least one list proposed to him within the form, notably a list of criteria sorted by number (N) of use and/or a list of recent criteria found by the management module thanks to their date of creation). In the embodiments in which a distinction is made between criteria used only by a single manager and those already used by several managers, a criterion is for example distinguished as a “public” criterion (Cpub) when it has been used by at least 2 different managers in evaluations of objects. On the other hand, a criterion that is used for the first time by a manager in a given assessment is distinguished as a “private” criterion (Cpriv) for this manager. A quality criterion which has been used for example two managers will be represented in the quality database (DB_Q) by a public criterion (Cpub) and two private criteria (Cpriv) which are identical but recorded for two different managers (i.e., associated with two different evaluations for example). Note that in these embodiments, the incrementing of the number (N) of use is not necessary when recording a new private criterion (because the fact that it's private and that there is no corresponding public criterion already defines that it has been used only once) or when creating a new public criterion (because the fact that the public criterion has been created already defines that it was used twice).

Therefore, in the embodiments distinguishing the public and private criteria, the recording of quality criteria data (CQ_O) in the quality database (DB_Q), triggered by the manager, is managed by the quality management module (GQ) (or module B or sub-module B4 as per various variants), which controls the creation in the database (DB_Q) of data representing a so-called private criterion (Cpriv), and of data representing an association of this private criterion with evaluation data (EV_G) of the manager. This creation may be performed when this criterion is used for the first time by the manager, for the category (CO) in which is referenced the object (O) being evaluated by the manager, may this criterion already exist in the database or not (as a public or private criterion). Furthermore, when a second manager, as evaluation criterion, selects a private criterion (Cpriv) introduced by a first manager, the quality management module (GQ) (or module B or sub-module B4 depending on variants) controls the creation, in the quality database (DB_Q), of data which represent a so-called public criterion (Cpub), in association with the category (CO) in which the object (O) being evaluated is referenced. In this case, the quality management module (GQ), in the quality database (DB_Q), can increment the number (N) of uses of the public criterion (Cpub) and create data representing a private criterion (Cpriv) in association with the evaluation data (EV_G) of the second manager who uses this criterion for the first time. In addition, it can also create, in some embodiments, data representing an association between the public criterion (Cpub) and the private criteria (Cpriv) in the identification data (ID_G) of the two managers, to associate the managers with the public criterion (Cpub) in the quality database (DB_Q). This association of the public criterion to the private criterion in the managers' identification data (ID_G) allows to identify managers using a public criterion (Cpub) and to keep the private criterion (Cpriv) in the evaluation data (EV_G). Thus, if the public criterion (Cpub) had to be cleared, for example for reasons of maintenance or moderation by the administrators of the Quality server (SQ), the private criterion (Cpriv) would be kept for each of the managers who used it. Finally, when a third manager selects, as an evaluation criterion, a public criterion (Cpub) already used by at least two managers, the Quality Management module (QM) (or module (B) or sub-module (B4) according to various variants) is arranged to only create the private criterion data (Cpriv) for this third manager and associations, firstly, of the public criterion (Cpub) selected with this criterion Private (Cpriv) and, secondly, of this private criterion with the evaluation data (EV_G).

Therefore in some embodiments of the method in which the private and public criteria are distinguished, as shown in FIG. 4, the creation (6100) of quality criteria data (CQ_O) in the quality database (DB_Q) by the quality management module (GQ) comprises at least the creation (6101) of data representing a so-called private criterion (Cpriv), and the creation (6111) of an association of the latter with the evaluation data (EV_G) of the manager. These creations are implemented either when the manager selects (6017) the creation of a new criterion, or when the manager selects (6024) an existing criterion. The selection (6024) of an existing criterion may comprise a selection (6032) of a recent criterion. In the embodiments distinguishing the private and public criteria, the selection (6024) of an existing criterion can comprise a selection (6027) of a public criterion and/or a selection (6023) of a private criterion, either directly or via the selection (6032) of a recent criterion. Moreover, when the manager selects (6027) an existing criterion that was a public criterion (Cpub), the creation (6100) also includes an association (6103) of the created private criterion (Cpriv) with this criterion Public (Cpub). Finally, when the manager selects (6023) an existing criterion that was a private criterion (Cpriv), the creation (6100) also includes a creation (6102) of a public criterion (Cpub), an association (6120) of the public criterion (Cpub) with the category (CO) and the association (6103) of the created private criterion (Cpriv) with this public criterion (Cpub).

For allowing the selection of the most relevant criteria, the creation (6100) may be accompanied by an incrementing (6104) of the number of uses (N) of the public criterion (Cpub), as mentioned previously.

In some embodiments, when the manager selects (6030) a link “recent criteria”, the Quality Management module (GQ) transmits (6031) a specific form containing a list of recent criteria, for example sorted by date or popularity. The selection (6032) of at least one of these criteria by the manager allows him to choose at least one recent criterion for the implementation of the creation (6100).

In some embodiments, upon the selection (6024) of an existing criterion or upon the selection (6032) of a recent criterion, may it be a selection (6027) of a public criterion (Cpub) or a selection (6023) of a private criterion (Cpriv), a transmission (6028) of the completed criteria form (with this selection) enables the quality management module (GQ) to receive the chosen criteria. In some embodiments, for example by selecting a dedicated link, the manager can lengthen the list of the most popular criteria by means of a button in the form, or can request the display of recent criteria, or can create a new criterion for example if the list of most popular criteria is found to be insufficient.

In some embodiments, upon the selection (6017) of a “new criterion” link, a new criterion creation form is transmitted (6018) to the manager who can enter (6019) the criterion of his choice (for example a short name and an assertion in respective fields). In some advantageous embodiments, the quality management module (GQ) is arranged, before generating quality criteria data (CQ_O) in the quality database (DB_Q), to verify the existence of at least one criterion identical or similar to the one entered by the manager, and if any similarity is detected, to propose a choice to the manager between the entered criterion and the detected similar or identical criterion (or criteria). The quality management module (GQ), before the creation (6100) of quality criteria data (CQ_O) in the quality database (DB_Q) performs at least one verification (6034, 6035) to verify the existence of an identical or similar criterion to the one entered by the manager, and if similarity is detected, performs a suggestion (6036) of a choice to the manager between the entered criterion and the detected criterion. For example, at the time of entry (6019), Web 2.0, Ajax technology allows the display of already known criteria having the same syntax as the one just entered (notably in the “short name” field) for a first verification (6034). Next, after the entry has been completed, a second verification (6035) can be made by a search in the quality database (DB_Q) for close criteria that have already been entered. For this purpose, the quality management module (GQ) may comprise at least one search algorithm, such as a syntax similarity search algorithm (for the short name for example) and/or a phonetic similarity algorithm (e.g. of “soundex” type) and/or a synonym algorithm (for the short name and/or assertion for example). Once the entry is completed and validated (6020), the new criterion is transmitted to the quality management module (GQ) performing the creation (6100). In the embodiments in which a distinction is made between private criteria and public criteria, this creation (6100) comprises the creation (6101) of a private criterion (Cpriv), preferably accompanied by an association (6111) of this private criterion with the evaluation data (EV_G).

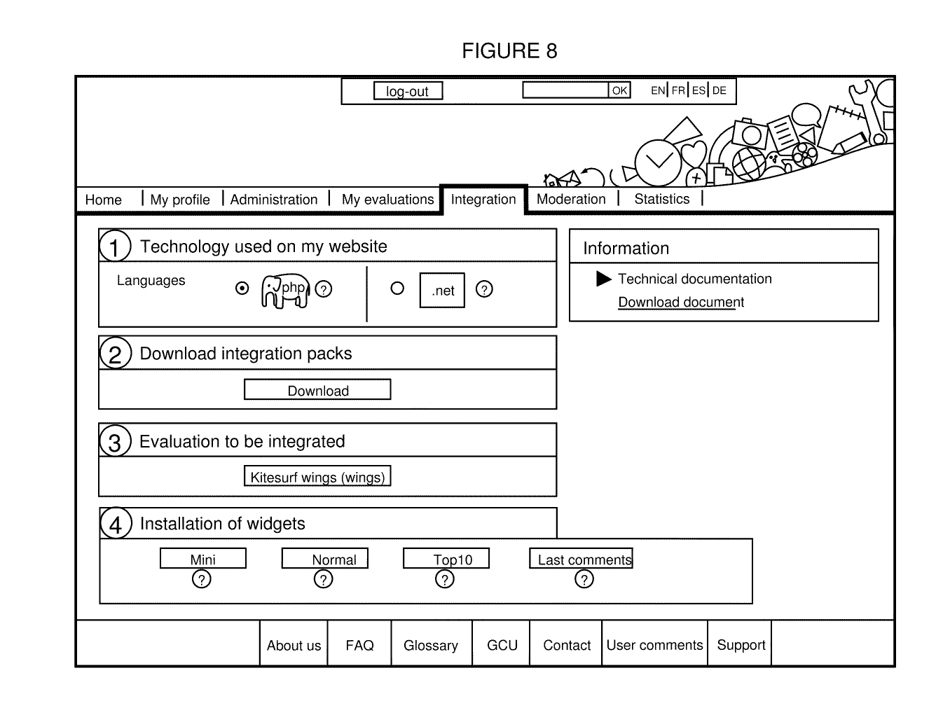

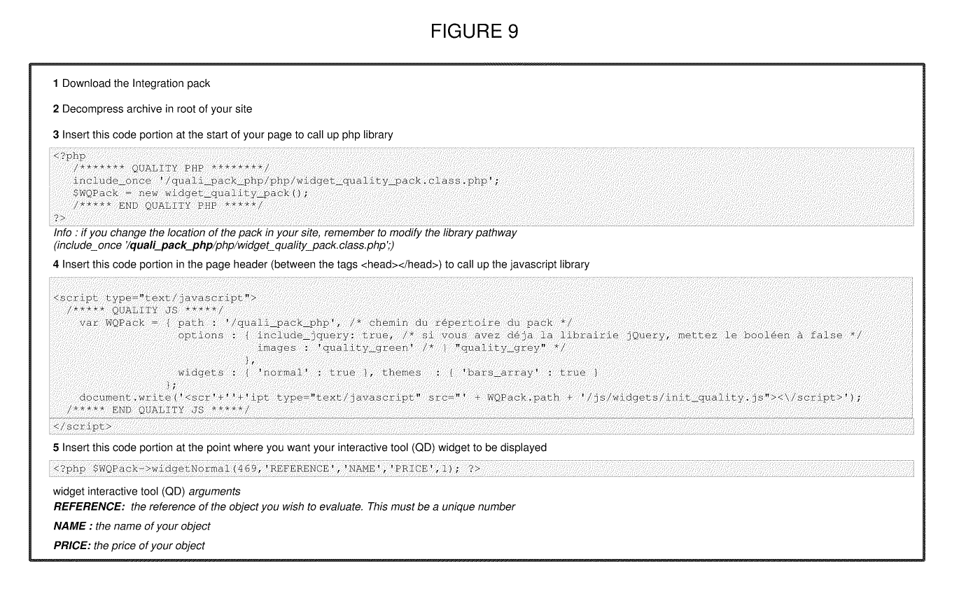

For the collaboration of internet users regarding the management of quality data, the invention provides for interactive tools. These interactive tools (QD, WR) form a graphical interface for interaction directly with the quality management module (GQ) by means of at least one link displayed on this interface, which can be selected by the internet user and directed towards at least one function of the quality management module (GQ). These tools are generated by the quality management module (GQ), or a dedicated integration module (C), from at least part of the data of the quality database (DB_Q), allow other types of data to be generated therein, and permit the use of various types of data from this database. In particular, the invention makes provisions for at least one interactive tool (QD, WR) for collaboration between internet users in the management of data relating to objects, via at least one communication network (RC). This interactive tool (QD, WR) is arranged to be executed in the navigator (browser) of at least one communication terminal (I1, I2) of at least one internet user and forms a graphical interaction interface of the internet user directly with the quality management module (GQ), by means of at least one link displayed on this interface, which can be selected by the internet user and directed towards at least one function of the quality management module (GQ). Therefore, in these embodiments, the management server (SQ) comprises a quality management module (GQ) arranged to allow collaboration, in the management of quality data, of internet users accessing at least one website (SW) of a manager, by generating and transmitting to the manager at least one tag (Tag_Q, Tag_R). This tag may be generated for example by the integration module (C) as illustrated in FIG. 1. The tag is then integrated by the manager in the source code of at least one web page (PW) on his website (SW). For example, in the database (DB_G) storing the data required for his website (SW) and within the scripts for the various web pages (PW) of his site (SW), the manager integrates the tags (Tag_Q, Tag_R) to provide visitors to his site with the operating functions of the present invention. The invention provides for various types of integration methods, to generate various types of tags, in relation to the language used in the source code of the website (SW), such as the languages php and .net in FIG. 8 (but also other languages such as jsp for example or any other language). FIG. 9 shows, in the example of php language, the integration method provided for the managers. The tag (Tag_Q, Tag_R) and data required for integration of the tag in the website (SW), then the data needed to execute the interactive tool (QD, WR), are therefore provided by some embodiments of the quality management server (SQ). The tags (Tag_Q, Tag_R) are arranged so that when the navigator of an internet user's communication terminal (I1, 12) requests access to this web page (PW), the manager's server (SG) uses this tag (Tag_Q, Tag_R) directed towards the quality management module (GQ) to obtain from the latter, for integration in the data of the web page (PW) transmitted to this navigator, the data that is needed for the execution and functioning of the interactive tool (QD, WR) in this navigator.

In some embodiments, the interactive tools comprise an interactive voting tool (QD), arranged to present internet users with the votes relating to at least one quality criterion for an object. The tag (Tag_Q) for this voting tool is generated by the quality management module (GQ), for example the integration module (C), for each of the evaluation data (EV_G) created by a manager. The tags (Tag_Q) directed towards the interactive voting tools (QD) are preferably generated for each new evaluation (EV_G) of an object (O) referenced in the quality database (DB_Q) by a manager. The interactive voting tools (QD) therefore enable an internet user to interact with the criteria for each evaluated object (O). The integration of this tag (Tag_Q) in the source code of at least one web page (PW) of the manager's website (SW) permits the defining of object data (O) representing the evaluated object. The quality management module (GQ), for example by means of voting module (D) which is contacted by the manager's server (SG) hosting this page (PW) at the time of access by a communication terminal (I1, I2) to this page (PW), is arranged to consult the quality database (DB_Q) to extract therefrom or to create therein, if such does not already exist, the object data (O) representing the evaluated object. Also, it is arranged at least to extract from the quality database (DB_Q), if such data exists, object voting calculation data (OVC), associated with these object data (O) and representing the number of times each of the values (ratings) from among a determined scale of values (ECH) has been selected by internet users for each of the available criteria (CQ_O) for the object (O). In these embodiments, these object voting calculation data (OVC) are not created for as long as the internet user does not validate his vote. In other embodiments, it may also be arranged to create this data, if it does not already exist, without waiting for validation of the vote, and as soon as the interactive voting tool (QD) is instantiated, for example by displaying a prompt message for the internet user to vote and allow the allocation of values to this as yet blank data.

Also, in some embodiments, the quality management module (GQ), for example by means of a voting module (D) is arranged, on the basis of object voting calculation data (OVC), to determine and transmit to the interactive tool (QD) at least one summary representation (RS) of votes from internet users for each criterion available for the object, or a prompt message inviting the internet user to be the first to vote if this object voting calculation data (OVC) does not exist in the quality database (DB_Q) (or if they are blank). The interactive voting tool (QD) is arranged to display on the communication terminal, firstly, information relating to the object itself, by means of the object data (O), and, secondly, this summary representation (RS) or this prompt message. In some embodiments proposing various vote presentation modes, the quality management module (GQ) also consults the evaluation data (EV_G) to find information on the representation theme chosen by the manager and to produce the summary representation according to this choice. This production of the representation can be made before or at the time of consulting the database to find the object voting calculation data (OVC). By means of these operating functions, in some embodiments, the internet user is able to obtain another type of summary representation (RS) if so desired, by selecting a link in the interactive tool directed towards a dedicated function of the quality management server (SQ).

In addition, in some embodiments of the interactive voting tool (QD), this tool is arranged to display a voting link which can be selected by internet users on their communication terminal, and directed towards the quality management module (GQ) (for example towards the voting module D). This module of the quality management server (SQ) is arranged to send the tool a voting form when this link is selected, this form being displayed on the internet user's communication terminal. This form comprises at least one selection or entry field enabling the internet user to allocate, to the object (O) with which the interactive voting tool (QD) is associated, a value (rating), from among a scale of values (ECH) proposed in the form, for each of the criteria (CQ_O) available for this object (O). This form may also comprise at least one validation field which can be selected to send the completed form to the quality management module (GQ). This latter module is arranged to receive the form and, on the basis of the data therein, to create in the quality database (DB_Q) at least criteria voting data (VC) which represent the value (rating) given by the internet user to the object (O) for each criterion (CQ_O), from among a scale of values (ECH) proposed in the form. This module is also arranged to create, if such do not already exist, or to update the object voting calculation data (OVC) in the quality database (DB_Q), on the basis of these criteria voting data (VC).

In some embodiments at the time of this voting, the internet user must allocate a value (rating, FIG. 1) to each of the criteria. However, in other embodiments, it may be possible not to allocate one of the proposed values to the object but to enter a specific value, for example in another field, to justify that no vote has been given to a given criterion either because this criterion is found to be irrelevant or because the criterion has not been understood. In other embodiments, the values proposed for each of the criteria may include at least one value for this selection of non-relevance (and/or non-use) of a criterion. In these various embodiments, the criteria can be re-evaluated over time, notably by keeping the different types of data representing the use or non-use of a criterion, for example during a moderation phase by managers and/or by administrators of the quality management server (SQ) itself. Therefore, firstly, by enabling internet users to vote on objects in relation to criteria, the interactive tool can be used to gather and disseminate information on the quality of objects, and, secondly, by enabling managers to see whether their criteria are used by users who vote, the interactive tools contribute towards the defining of criteria. Additionally, as mentioned previously, this defining of criteria is advantageously obtained in various embodiments of the present invention by the quality management module (GQ) through the evaluation of the popularity of criteria used by the different managers and through the converging towards most used criteria, which takes place on account of their presentation in order of popularity at the time evaluations are recorded by the managers.

In some embodiments, the quality management module (GQ) is also arranged for generating, on receipt of the vote form, voting data (V) representing general information relating to (on) the vote, for example the date of voting and/or name of the internet user if identified via the voting form. This voting data (V) will be associated in the quality database (DB_Q) with the criteria voting data (VC) and object data (O). Also, in some embodiments, the vote form comprises other selection and/or entry fields so that the quality management module (GQ), on the basis of selections and/or entries by internet users in these fields, can create at least one type of data item from among the following:
vote comment data (CoV), representing general comments on the object,
criteria comment data (CoC), representing comments on the object for each of the available criteria,
publication data (DV) corresponding to files transmitted by internet users to the quality management module (GQ), such as image, video or other files.

In these embodiments, the voting data (V), in the quality database (DB_Q), can also be associated with vote comment data (CoV) and/or with publication data (DV). The criteria voting data (VC) is preferably associated with the criteria comment data (CoC) since they concern criteria individually. In some variants, publication data (DV) can be generated also for each of the criteria, from the corresponding fields in the voting form. This publication data (DV) on criteria are then associated with the criteria voting data (VC). Therefore internet users are able to publish an image or video for example for each criterion (for example to show why they think that the object is worth the rating they have allocated to a given criterion).

In some embodiments, the summary representation (RS) is generated based on object voting calculation data (OVC), thanks to at least one representation algorithm permitting:
the calculation of an average score of the object for each of the criteria, on the basis of the object voting calculation data (OVC),
the sorting of criteria per average score, and
an intuitive representation in relation to a representation theme chosen by the manager in the evaluation data (EV_G).

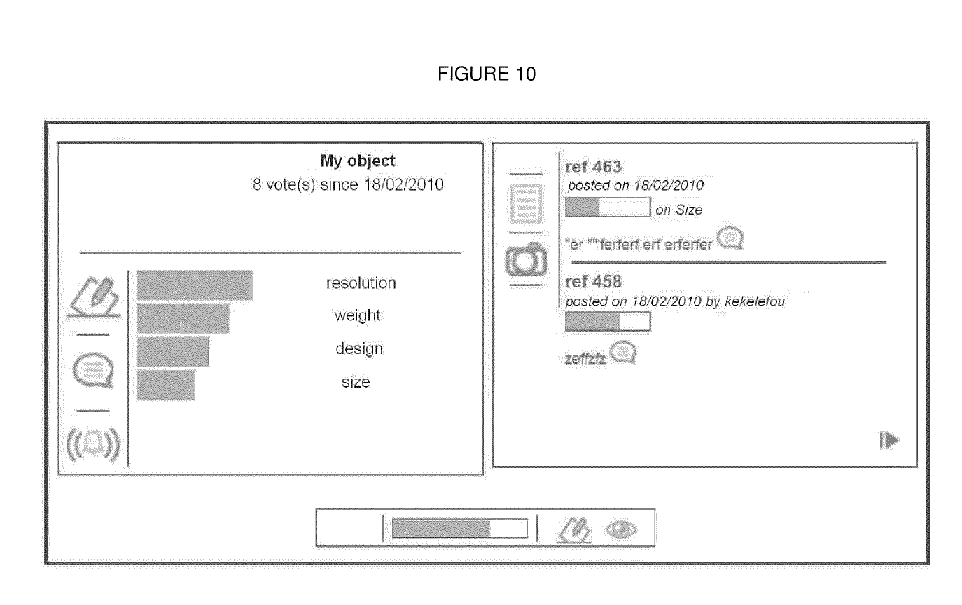

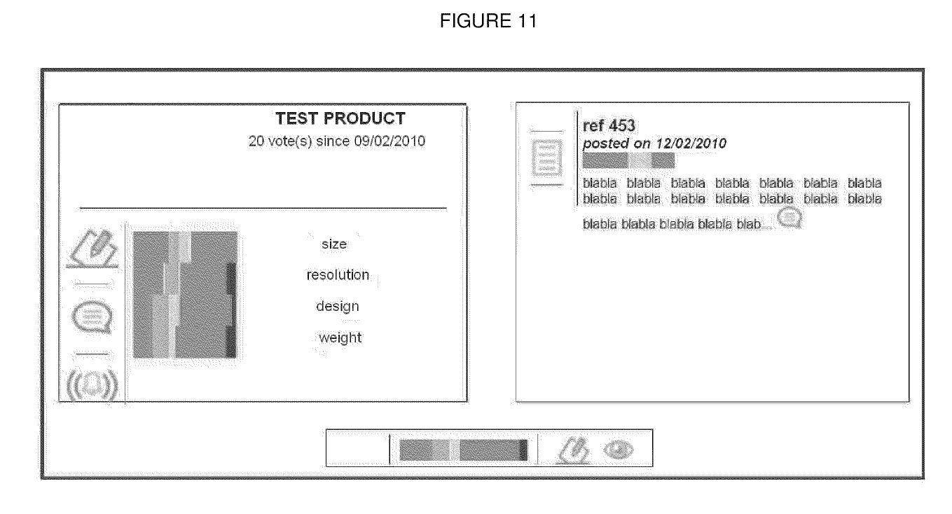

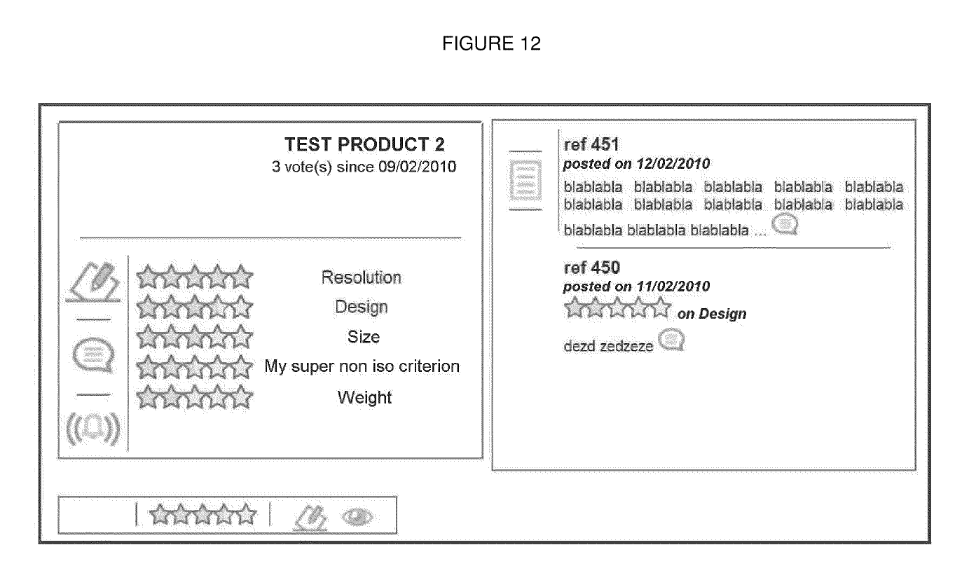

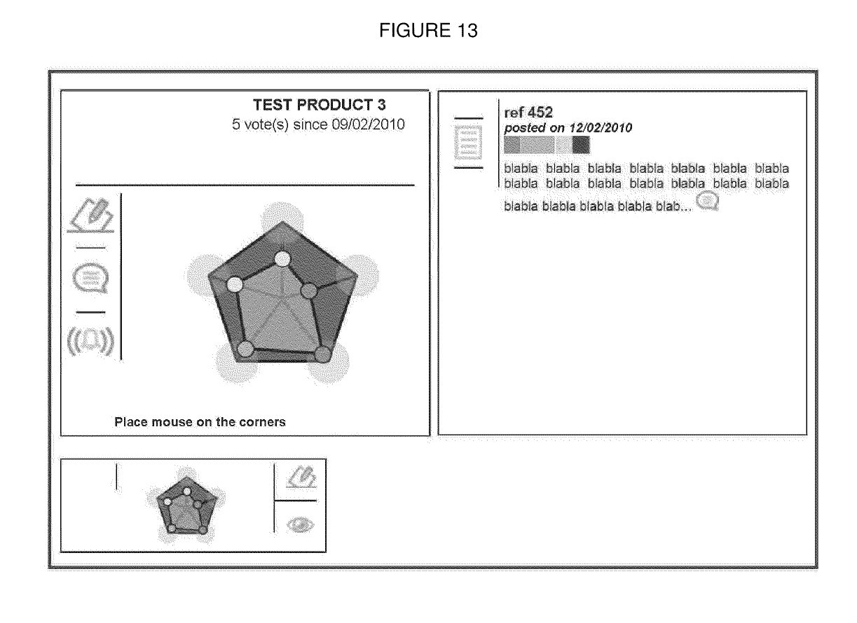

In some embodiments, the criteria may assume several discrete values (e.g. 5) on a scale (ECH). These values can be represented by colours or other form of representation (histograms, stars, smileys, radars, etc. as shown in FIGS. 10-13 for example). In some examples, the scale (ECH) is defined by the chosen theme, but may have a given number of values (e.g., 5) irrespective of the theme. In some embodiments, the theme and/or the scale can be modified by the internet user and the quality management module (GQ) will apply the algorithm corresponding to the selected scale (ECH) and/or theme. One example of an algorithm for the calculation of an average score is detailed below. In this example, sorting consists of classifying criteria per decreasing average score. The summary representations made possible by said calculation of an average score are illustrated in FIGS. 10-13. In particular, this type of algorithm, notably by means of the distinction made between the values (rating) allocated by all internet users to each of the criteria, allows a representation of “Regnier abacus” type which summarizes all data in one same graph, for example as illustrated in FIG. 11. Note that, particularly in the embodiments where the votes allow users to justify the absence of vote, this type of abacus allows a representation of information relating to this justifying (which allows to know why a criterion is not or rarely used and thus allows improving the database).

For the summary representation (RS) of the votes allocated to the object (for each of the criteria), a calculation algorithm enabling a sorting of the criteria by a decreasing average score can be used, based on the object voting calculation data (OVC). This algorithm allows organizing the evaluation criteria as a function of a [symbol] favorable (or positive) consensus [symbol] , that is to say the score (or rating) allocated to the object for each of the criteria. The criteria with the best scores may for example be at the top of the list.

The object voting calculation data (OVC) are used to collect the votes of internet users for an object, on the basis of criteria voting data (VC) by which internet users vote (allocate a value (rating, FIG. 1) to the object) for each criterion. For each criterion, the voter chooses a value (rating) on a discrete scale (ECH) (for example colour and/or text indicating to what the vote corresponds). This value (rating) represents the voter's opinion and will be characterized by a weight in the calculation algorithm. For example, for a given object, 6 criteria may be available and internet users will allocate a value to the object for each of these 6 criteria. The object voting calculation data (OVC) for a given object is used for example to draw up a table of criteria organized as per decreasing average score (or decreasing “favourable consensus”).

To complete the table, the values (ratings) allocated for each criterion (e.g. in the rows of the table) are represented as a percentage relative to each other. A weight is allocated to each value by the calculation algorithm. For example, the values representing positive votes (e.g. green colour and/or corresponding to “very good” or “fully agree”) will be given a maximum weight on a weight scale, and lower values (in terms of significance of the internet user's agreement with the assertion corresponding to the criterion) are given lower weights. For example, on a scale of 5 values (ratings) for each criterion:
the most positive value (rating), for example dark green, is given a weight of 5,
the lower value (rating), for example light green, is given a weight of 4,
the lower value (rating), for example yellow, is given a weight of 3,
the lower value (rating), for example orange, is given a weight of 2,
the most negative value (rating), for example red, is given a weight of 1.

By means of this weight given to values and the percentages they obtain in the object votes (OVC), a score is calculated for classification. For example the weight is multiplied by the percentage of each value (rating in colour in the above example) and the criteria are then classified per decreasing score. The percentage of the values for each criterion can be used to determine the summary representation (RS). In some cases, as in FIG. 11 for example corresponding to a Regnier abacus, the representation shows the percentages of each value.

The algorithm to sort per average score can be obtained for example by means of the following sequence of instructions (solely given in an illustrative and non-limiting manner):

Function getCriterWeight(IdObject /* object identifier */)

criterWeight = [empty];
colours = [

[weight = 5, colour = #009933 (dark green)],
[weight = 4, colour = #00FF00 (light green)],
[weight = 3, colour = #FFFF00 (yellow)],
[weight = 2, colour = #FF9900 (orange)],
[weight = 1, colour = #FF0000 (red)]

];

[symbol]

criteria = getCriterEvaluation(IdObject);
for each criterion => currentCriter

weightItem = 0;
numberVoteCriterion =
getNbVoteCriter(currentCriter[identifier],

IdObject);

```
for each colour => currentColour
  numberVoteCriterColour =
  getNbVoteCriterColour(currentCriter
```

[identifier], currentColour[identifier], IdObject);

if numberVoteCriterColour > 0 then
percent = round( (numberVoteCriter /

numberVoteCriterColour) * 100, 2);

criterWeight[ CurrentCriter[identifier]
][‘percent’][ colours

[identifier] ] = percent;

weightItem += percent * CurrentColour[weight];

end if

```
  end for
  WeightCriter[ currentCriter[identifier] ][‘weight’] = weightItem;
end for
Return SortPerDecreasingWeight(criterWeight);
```

end Function

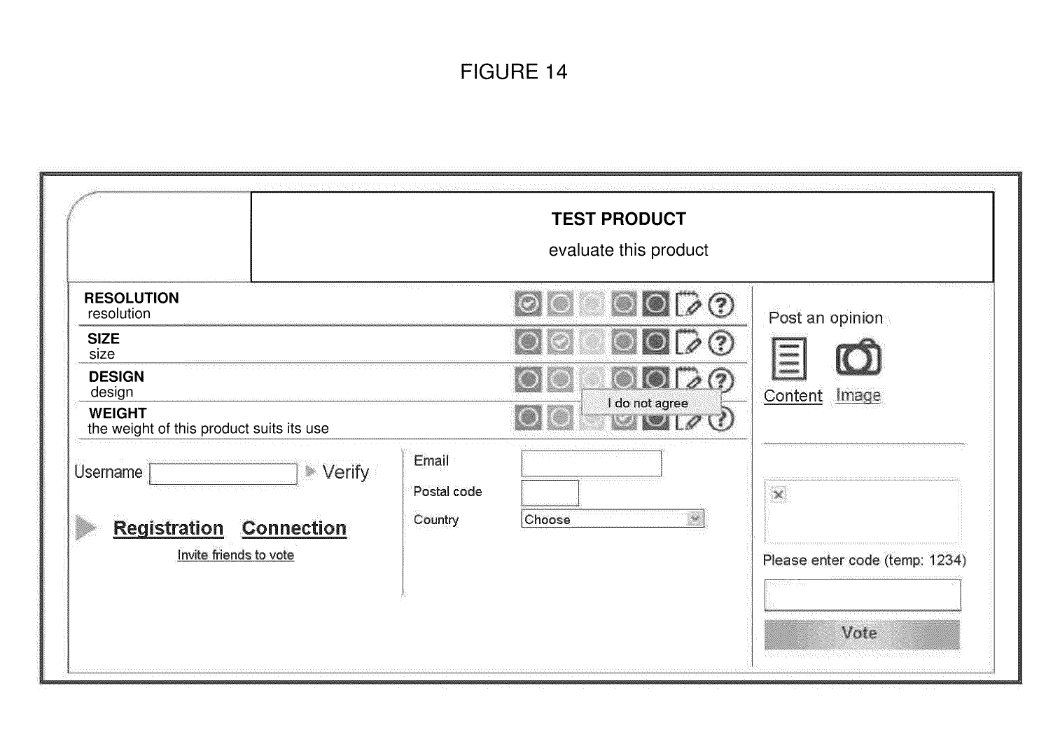

Following this presentation of the summary representation (RS), the internet user can also vote to allocate to the object a desired value for each criterion. FIG. 14 is an illustration of an example of a voting window (or form) with the possible selection/entry fields. This example particularly shows each value, represented by a colour, which can be selected and its browsing is accompanied by the display of text explaining its meaning.

Also, in some embodiments, the invention provides for different types of summary representations (RS) and even different forms of one same summary representation. Various forms of a summary representation are depicted in each of FIGS. 10-13. In each of these figures are illustrated:
at the bottom of the boxed text: a “rolled up” form in which the average scores of criteria are contained in a mean for all the criteria,
top left: a “rolled out” form in which the average criteria scores are detailed for each criterion,
top right: a “scrolled” form showing the votes allocated by internet users.

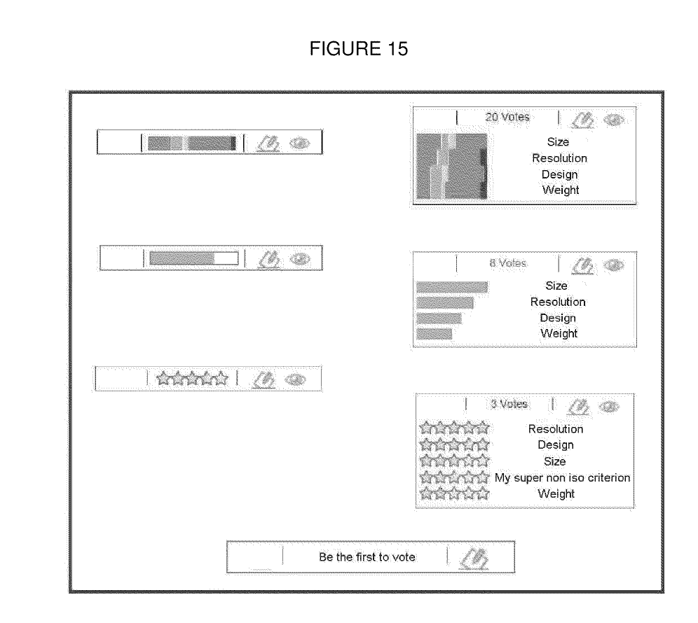

FIG. 15 shows the “rolled up” and “rolled out” forms of the summary representations (RS) of FIGS. 11, 10 and 12 (from top to bottom) and a blank representation (very bottom) in which there is a prompt message to vote (for cases in which object voting calculation data (OVC) does not exist or is blank). Obtaining the different representation forms can be made for example by selecting link(s) in the interactive tool. For example, the icon symbolizing an eye in these figures can be used to roll out/roll up a rolled up/rolled out form, and the icon symbolizing a pencil and sheet of paper can be used to vote.

In some embodiments, the interactive tools comprise an interactive search tool (WR), the tag (Tag_R) for this tool being generated by the quality management module (GQ) for each of the identification data items (ID_G) created by a manager. The tags (Tag_R) directed towards the interactive search tools (WR) are preferably generated for each manager registered in the quality database (DB_Q) (thanks to the identification data (ID_G) of the managers). The interactive search tools (WR) can then be used to search for criteria among all the objects (O) of all the categories (CO) of objects offered by the manager on his website (SW). The integration of this tag (Tag_Q) in the source code of at least one web page (PW) of the manager's website (SW) allows the search tool (WR) to access the manager's identification data (ID_G) and/or to evaluation data (EV_G). The quality management module (GQ), contacted by the manager's server (SG) hosting this web page (PW) at the time of access by a communication terminal (I1, I2), is arranged, for example thanks to a search module (G), to consult the quality database (DB_Q), to extract therefrom the category data (CO) and the criteria data (CQ_O) associated with the manager's evaluation data (EV_G). Additionally, the quality management module (GQ), for example by a search module (G), is also arranged to send a search form to the search tool (WR) containing selection and/or entry fields enabling internet users to select at least one category in which they wish to search an object, and for each category, to select at least one choice of criterion (CQ_O) or choice of order of priorities of a plurality of criteria (CQ_O). The form may comprise at least one validation field to send the form, via the interactive search tool (WR), to the quality management module (GQ) (or search module G) arranged to search in the quality database (DB_Q) for those object data (O) on the manager's website (SW) which correspond to this selection of criteria (CQ_O).

In some embodiments, the search tool can be made accessible by a search link in a web page (PW), and the various resources implemented, as described herein, for the sending and gathering of search form data are triggered by selection of this search link by the internet user instead of being triggered by detection of a tag by the manager's server (SG) (since the tags for all the types of interactive tools envisaged by the present invention may be detected). Therefore, in some embodiments, the tool is an interactive search tool (WR) displayed in at least one web page (PW) and comprising at least one search link directed towards a function of the quality management module (GQ) to send the internet user's navigator a search form containing selection and/or entry fields enabling the internet user to select at least one category in which it is desired to search an object and, for each category, to is select at least one choice of criterion (CQ_O) or choice of order of priority of a plurality of criteria (CQ_O), the form comprising a validation field to send the form, via the interactive search tool (WR) towards the quality management module (GQ) arranged to retrieve this selection in the form and to search in the quality database (DB_Q) for those object data (O) on the manager's website (SW) which correspond to this selection of criteria (CQ_O).

In some embodiments, the quality management module (GQ) is arranged (for example by means of a search module G), firstly, to search in the quality database (DB_Q), for object data (O) which are associated with the criteria (CQ_O) selected by the internet user in the search form, and for object voting calculation data (OVC) associated with these object data (O), and, secondly, if the internet user's selection comprises an order of priority of a plurality of criteria (CQ_O), to sort the objects found in relation to a classification score allocated to each of the criteria available for each of the objects and calculated on the basis of the value (rating) of these criteria in the object voting calculation data (OVC) using a coefficient applied to each criterion in relation to its ranking in the order of priority, and then to send a result page of this search and sorting to the search tool (WR) for display on the internet user's communication terminal. (I1, 12).

The quality management module (for example by means of an integration module C) can generate the tags (Tag_R) for a search after identification of the manager (registration module A) and/or tags (Tag_Q) for voting after evaluation of an object (evaluation module B). The two types of tools can evidently be grouped together in one same tool integrating the function links for search and the function links for internet user interaction. Other interactive tools or other functions of these tools can be provided and the examples given herein, particularly advantageous for the dissemination of the quality criteria of the invention, are not limiting.

In some embodiments, the links on the interactive tools also comprise (or are associated with) at least one entry field, notably for identification of the internet user, associated with a key (or link) to validate the entry. Identification of the internet user allows the actions taken by an internet user using one of the interactive tools to be saved in the quality database in association with the data representing the account of this internet user. Entry fields other than those for identification are also provided, notably to post comments for example. In the interactive search tool (WR), validation of the search form may be made by selecting a function link directed towards the quality management module (GQ) so that it carries out a search corresponding to the search form that has been sent. In general, the quality management module is arranged to interact with the internet user via the interactive tools. An interaction module (F) can be dedicated to the various possible interactions. In some embodiments, these function links are displayed in the form of an icon for example, forming an intuitive representation of the function associated therewith on the quality management server (SQ).

In some embodiments, the link towards the voting function also enables internet users to post at least one comment, as explained previously. In various embodiments, the tools comprise different function links enabling internet users, independently of the vote, in addition to the vote or at the same time as the vote, to post a general comment and/or a comment per criterion and/or at least one image and/or at least one video and/or any type of data. This data (comment, image, etc.) will be stored in the quality database (DB_Q). It will be appreciated on reading the present application that the function links are directed towards the quality management module (GQ) and/or towards at least one of the dedicated modules (D, E, F, G, H) since the functions are performed by at least one module as explained above. Function links may also be directed towards modules (A, B, C) dedicated to the managers, notably if the users of the interactive tools are identified managers. In some embodiments, the interactive tools (or tool) are of “widget” type (contraction of windows and gadget).

Integration of the tags (Tag_Q, Tag_R) on the site is made by copy/paste of an integration pack by the manager in the scripts of his website (SW) on his server (SG). The interaction by internet users with the user tools is then made with the quality management module (GQ) directly (for example by means of a cache module E, or on-the-fly interaction module F and/or a voting module D and/or a search module G and/or a zoom module H, according to the various embodiments).

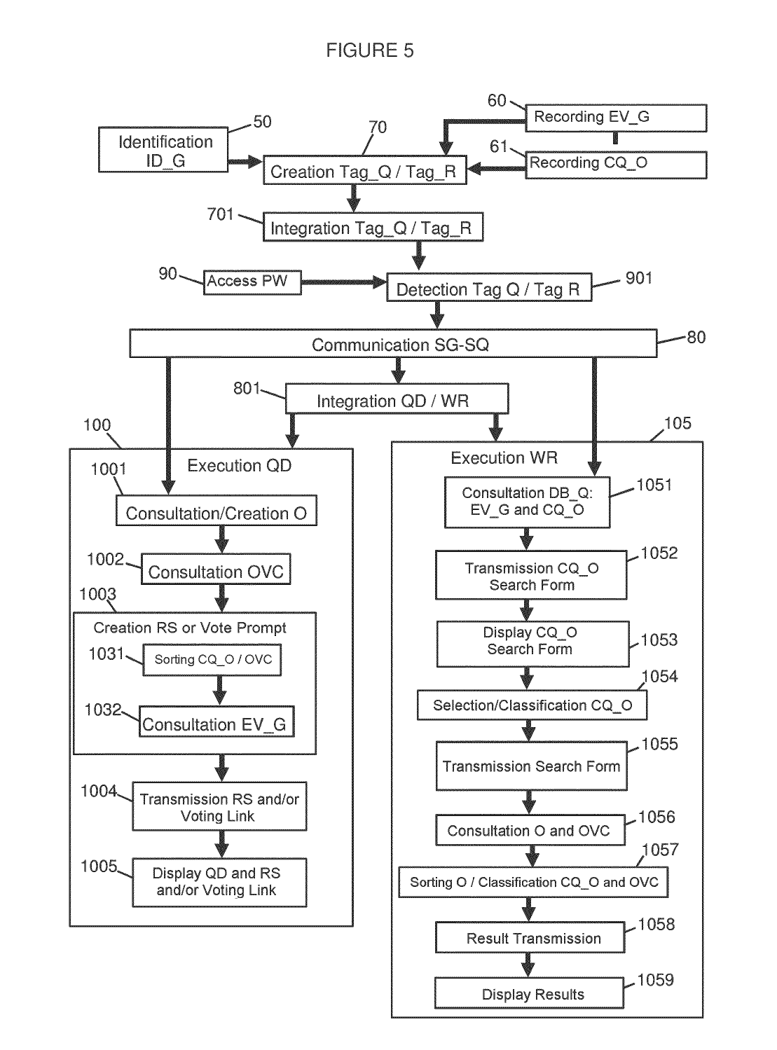

As mentioned previously, the present invention also concerns a method to manage quality data. In the various embodiments using the interactive tools, one method to manage this quality data, of which an example is given in FIG. 5, may comprise at least one creation (70) of at least one tag (Tag_Q, Tag_R) by the quality management module (GQ), to allow collaboration between internet users accessing at least one website (SW) of a manager. A tag integration (701) by the manager of the website (SW) in the source code of at least one web page (PW) of his website (SW) makes it possible, during an access (90) by the navigator of an internet user's communication terminal (I1, I2) to this web page (PW), for the manager's server (SG) to detect (901) this tag (Tag_Q, Tag_R) directed towards the quality management module (GQ), and uses it to communicate (80) with the latter and to obtain the necessary data for execution (100, 105) and functioning of the interactive tool (QD, WR) in the navigator. The manager's server (SG) then performs an integration (801) to integrate this obtained data in the data of the web page (PW) transmitted to this navigator.

In some embodiments, this method comprises an execution (100) of at least one interactive voting tool (QD) relating to an object (O), the tag (Tag_Q) for this tool being generated (70) by the quality management module (GQ) for each of the evaluation data items (EV_G) created by a manager, the integration (701) of this tag (Tag_Q) in the source code of at least one web page (PW) of the manager's website (SW) enabling the definition of object data (O) representing the evaluated object. In some embodiments, this execution (100) is accompanied by the following:
consultation/creation (1001), by the quality management module (GQ), of object data (O) in the quality database (DB_Q), this data being consulted if it exists or created if it does not exist,
consultation (1002), by the quality management module (GQ), of the object voting calculation data (OVC) associated with this object data (O) and representing the number of times each of the values (ratings) from among a determined scale of values (ECH) has been selected by internet users for each of the criteria (CQ_O) available for the object (O),
creation (1003), by the quality management module (GQ), of at least one summary representation (RS) of internet user votes for each criterion available for the object, or of at least one prompt message inviting an internet user to be the first to vote if object voting calculation data (OVC) does not exist in the quality database (DB_Q),
transmission (1004) to the interactive voting tool vote (QD), by the quality management module (GQ), of the summary representation (RS) and/or voting link,
display (1005), by the quality management module (GQ), of the summary representation (RS) and/or voting link.

The voting link can be displayed in addition to the summary representation (RS) since this voting link prompts internet users to vote, whether or not votes already exist.

In some embodiments, the creation (1003) of the summary representation (RS) comprises a sorting (1031) of the criteria data (CQ_O) in relation to the object voting calculation data (OVC) and/or a consultation (1032) of the evaluation data (EV_G) to find the theme to be used for the summary representation. Sorting (1031) may be based on use of a sorting algorithm such as the one detailed above.

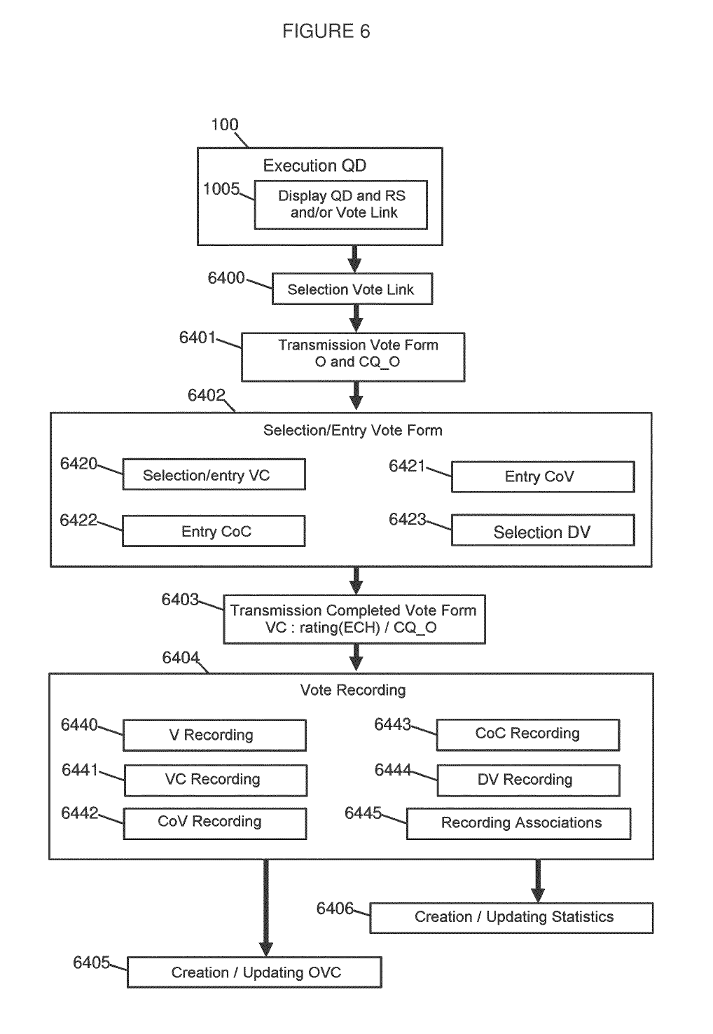

In some embodiments, of which an example is illustrated in FIG. 6, the display (1005) of a voting link, when selected (6400) by an internet user, is accompanied by the following:
transmission (6401), by the quality management module (GQ), of a voting form prepared from the object data (O) and quality criteria (CQ_O) associated with this object,
selection/entry (6402) in the voting form by the internet user of at least one allocation (6420) of a value (rating) from among a scale of values (ECH) proposed in the form, to each of the criteria (CQ_O) available for the object (O) with which the interactive voting tool (QD) is associated,
transmission (6403) of the completed voting form with the value (rating) allocated to each criterion (CQ_O),
recording (6404), by the quality management module (GQ), at least by recording (6440) criteria voting data (VC) representing the value (rating) allocated by the internet user to the object (O) for each criterion (CQ_O), from among the scale of values (ECH) proposed in the form,
creation/updating (6405), by the quality management module (GQ), of object voting calculation data (OVC) in the quality database (DB_Q), on the basis of this criteria voting data (VC).

In some embodiments, the selection/entry (6402) in the voting form by the internet user comprises at least one vote selection/entry (6420) for the criteria. In some embodiments, this vote selection/entry is accompanied, if the internet user so desires, by an entry (6421) of at least one voting comment (CoV) and/or an entry (6422) of at least one criterion comment (CoC) and/or at least one selection (6423) of at least one data file transferred from the internet user's terminal to the quality management server (SQ) which records the same in the quality database (DB_Q).

In some embodiments, the recording (6404) of the internet user's vote comprises at least one recording (6441) of criteria voting data (VC). In some embodiments, this recording is accompanied by a recording (6440) of “general” voting data (V) and/or a recording (6442) of vote comment data (CoV) and/or a recording (6443) of criteria comment data (CoC) and/or a recording (6444) of record publication data (DV) and/or a recording (6445) of association data between these different types of recorded data.

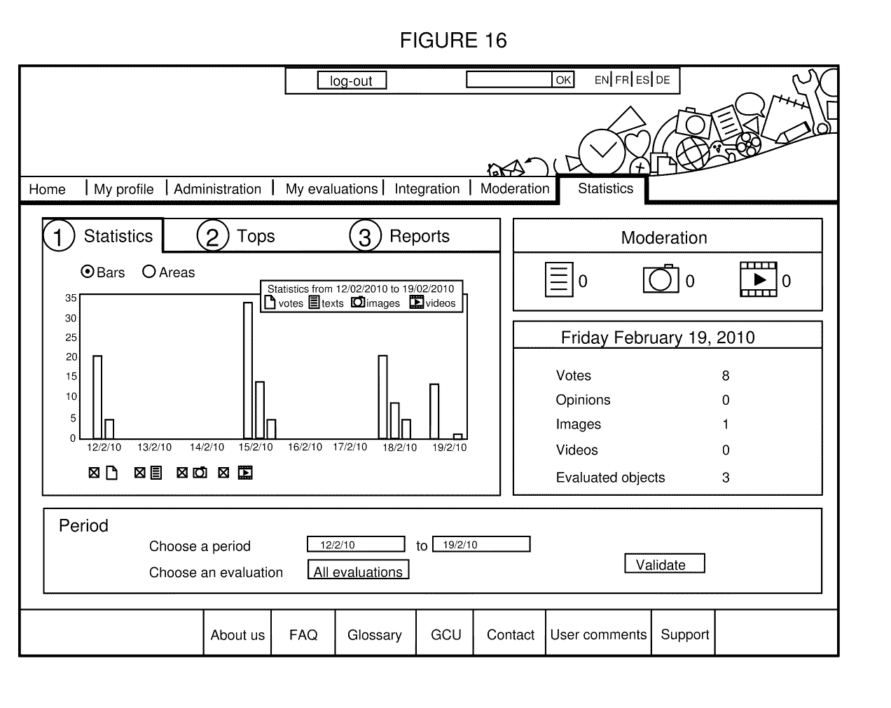

In some embodiments, the method may comprise a creation/updating (6406) of statistical data, for example representing the number of votes logged on a given day, on a given site, or any type of combination of information with other types of data. For example FIG. 16 includes a display of statistical data.

In some embodiments using the interactive search tools (WR), the invention provides for a method comprising at least one execution (105) of at least one interactive search tool (WR). The tag (Tag_R) for this tool is generated (70) by the quality management module (GQ) for each of the evaluation data items (EV_G) created by a manager. The integration (701) of this tag (Tag_R) in the source code of at least one web page (PW) of the manager's website (SW) permits the defining of object data (O) representing the evaluated object, this execution (105) being accompanied by the following:
consultation (1051), by the quality management module (GQ), of the evaluation data (EV_G) and criteria data (CQ_O) in the quality database (DB_Q),
transmission (1052) to the interactive voting tool (QD), by the quality management module (GQ), of a search form containing the criteria available for the site on which it is executed,
display (1053) of the search form on the internet user's communication terminal,
selection/classification (1054) of at least one criterion by the internet user,
transmission (1055) to the quality management module (GQ) of the completed search form,
consultation (1056) of object data (O) and object voting calculation data (OVC) in the quality database (DB_Q), in relation to the completed search form,
sorting (1057) of the objects (O) in relation to the voting calculation data (OVC), as per the completed search form,
transmission (1058), by the quality management module (GQ) to the interactive search tool (WR) of the data resulting from sorting of the objects (O),
display (1059) of the result of the sorting of objects (O) by the interactive search tool (WR).

During the consultation (1051), the available quality criteria data (CQ_O) can be determined from the manager's identification data (ID_G) and/or evaluation data (EV_G) from the site on which the interactive search tool (WR) is used, so as only to list the criteria for which the manager's site offers objects (O). Also, the presentation of these criteria can be accompanied by a sorting (6110) of the criteria as per the number (N) of their uses (implemented before or for transmission of the search form) so as give the internet user the most consensual criteria. Especially in embodiments where the user can assign a value or not to a criterion or can assign a value representing the non-relevance (or at least non-use) of the criterion, the presentation of these criteria can be accompanied by a sorting of criteria as per their use in the votes of Internet users. Next, classification (1054) will permit the internet user to modify of the order of criteria for the search, for example using a specific algorithm.

The quality management module (GQ) (for example by means of a dedicated search module G) makes it possible to retrieve a list of objects whose result is organized in relation to the evaluation criteria prioritized by the user. One example of said algorithm is detailed below:

The internet user chooses a category (CO), and the search module (G) retrieves the criteria (CQ_O) of the evaluations (EV_G) in category (CO) and presents these to the internet user on the search tool (WR). The internet user prioritizes the criteria by classifying them in an order of priority for the search (from the most relevant to the least relevant for example). For example, a list of criteria (criterion 1, criterion 2, criterion 3) is presented, and after prioritization the list of criteria is the following (criterion 2, criterion 3, criterion 1). The search module (G) then applies a coefficient to each of the criteria in relation to their priority (for example by decrementing from the highest priority, having the highest coefficient, to the lowest having the lowest coefficient). The search module (G) retrieves the list of all the objects (O) of the evaluations (EV_G) belonging to the selected category (CO), and then calculates a priority score for each object (based, firstly, on the value (rating) assigned to the object for each of the criteria (among the scale (ECH) of is values) and, secondly, on the coefficient allocated to the criteria as a function of the priority order defined by the internet user). For example, for each object a priority score, out of 100, is allocated to each of the criteria (calculated from object voting calculation data (OVC) for the object). The search module (G) then constructs the result of the search in the form of a table of objects sorted according to the priority of criteria, as per decreasing priority scores.

The algorithm sorting search results may be obtained, for example, by means of the following sequence of instructions (given solely by way of illustration and non-limiting):

tabCriter = array(IdentifierCriter2, IdentifierCriter3,
IdentifierCriter1) ;
tabCriter = inverseTable (tabCriter) ;
precision = 2 ;
multi = (10 power precision ) * 100 ;
tabCriterCoeff = array( ) ;
tabCriterCoeff[ tabCritere[0] ] = 1
lastId = tabCriter[0];
for i = 1 up to tabCriter.length − 1

tabCriterCoeff[ tabCriter[i] ] = tabCriterCoeff[lastId] *

multi + tabCriterCoeff[lastId] ;

lastId = tabCriter[i]

```
end for
tabObjetNote = array( ) ;
For each object
  For each tabCriter
  scoreCriterObject = getScoreCriterObject( object[‘identifier’],
```

tabCriter[‘identifier’]);

tabObjectResult[ object[‘identifier’] ] += scoreCriterObject *

tabCriterCoeff[tabCriter[‘identifier’] ];

End for

End for
tabObjectScore = sortObjectPerDecreasingScore(tabObjectResult);

For calculation of the priority score for criteria, the instructions could be as follows:

Function getNoteCriterObject (idObject /* object identifer */ ,
idCriter /* criterion identifier */)

#weight of criterion
weightItem = 0;
#table of colours
colours = [

[weight = 5, colour = #009933 (dark green)],
[weight = 4, colour = #00FF00 (light green)],
[weight = 3, colour = #FFFF00 (yellow)],
[weight = 2, colour = #FF9900 (orange)],
[weight = 1, colour = #FF0000 (red)]

];

numberVoteCriter =

getNbVoteCriter(currentCriter[identifier], IdObject);

for each colour => currentColour
numberVoteCriterColour =

getNbVoteCriterColour(currentCriter[identifier],
currentColour[identifier], IdObjet);

if numberVoteCriterColour > 0 then

percent = round( (numberVoteCriter /

numberVoteCriterColour) * 100, 2);

weightItem += percent * currentColour[weight];
end if

end for
MaxWeightColour = maximum weight of colours = 5
return round (weightItem / MaxWeightColour);

End function

As explained previously for the server and system, irrespective of whether the criteria were defined by collaboration from a consensus obtained through presenting the number (N) of uses, the invention may also concern a voting method or collaboration method between internet users for the determining of data on quality. In the embodiments in which the internet user does not necessarily vote on the object for each of the criteria, the voting data not only allow data to be obtained which is reliable but which also contributes to the selection of the most consensual criteria, since the least used or least relevant criteria are most likely to obtain few votes. The method may then comprise a moderation of criteria by verifying the number of votes given on the different criteria. The criteria for which few votes have been obtained may be omitted from the list presented to internet users (notably Automatically, for example thanks to a threshold of use, or manually by a moderator).

In some embodiments, the invention provides for the caching of data to avoid saturation problems, notably of the quality database(s) (DB_Q). The quality management module (GQ) is arranged, for example by means of a cache module (E), to create the data required for this caching. On the quality management server(s) (SQ), asynchronous processing for caching is launched periodically, for example every 5 minutes. The time of validity of the cache can be parameterized by the administrator of the quality management server (SQ). This caching is based on the generation of at least one interactive tool caching file, for example of “html” or “xml” type depending on whether the managers of the websites (SW) or the administrators of the quality management server (SQ) do or do not wish to transmit data permitting rendering. The interactive tool caching files contain all the data needed for the execution, the functioning and the display of an interactive tool (such as theme, criteria, votes, comments, publication data, etc.). When execution of an interactive tool is requested, the cache module (E) extracts at least one necessary cache file from memory means to which it has access (for example the same as those of the quality database (DB_Q) or preferably other memory means which are less likely to become saturated). For the periodical creation of caching files, the cache module (E) extracts from the quality database (DB_Q) the data required for the execution and functioning of at least one interactive tool (QD, WR) associated with at least one object (O). The creation of this data will have been made as explained herein (previously), and its extraction allows the generation of the caching files. For example, when demand is too high and the quality management module (for example an interaction module F and/or voting module D and/or search module G) fails to perform the functions (tasks) for which it is arranged, it is the corresponding cache file version from the previous period which is distributed (for display on the internet user's navigator), and there will not be any errors on the manager's site.

Therefore, in some embodiments, when execution of an interactive tool relating to an object is requested, the quality management server (SQ) can search whether a cache version of the interactive tool exists (attempted reading of cache file), whose name is for example constructed from at least part of the evaluation data (EV_G) and object data (O). In some embodiments, the cache module (E) creates a cache file of an interactive tool from the evaluation data (EV_G), criteria data (CQ_O), object data (O), and from the object voting data (OVC). If a cache version exists, the content of the file is sent by the cache module (E) to the manager's server (SG). Otherwise, interaction must take place by on-the-fly processing by the quality management module (GQ), for example by means of the interaction module (F). In this case, the interaction module (F) looks in the database to see whether there are any object data (O). If not, it creates this data containing information on the object (for example the reference, wording, price, URL of the object, URL towards photo of the object, technical characteristics, etc.). On the other hand, if these object data (O) exist, but differences have occurred between the manager's version and the version stored in the database (DB_Q), the module updates the data in the database (DB_Q).

Whether or not there exists a cache mechanism, in some embodiments if the quality management server(s) (SQ) do not respond, the invention makes provision for a “time-out” which is triggered after a pre-determined time (for example 5 or 10 seconds) and an error message in the interactive tool or a specific error tool is transmitted for display on the navigator, to avoid failed task performance by the manager's site. In cases when a caching mechanism does exist, the cache file version of the preceding period is transmitted and avoids this error message. However, the interactive tool extracted from the cache and displayed in the absence of response by at least some modules of the quality management server (SQ), may display a message of no update of the interactive tool (QD) and/or the time at which the last update was made.

Additionally, in some embodiments, the caching functions allow that at least part of the data needed for functioning are cached (for example the basic data concerning the interactive tool itself) and that only another part (for example data on voting or any other type of data which changes over time) require a “on-the-fly” access to the database. Therefore some data can be permanently stored beforehand and others are consulted dynamically to limit access to the database storing the data that is dynamically consulted.

Some embodiments of the method can therefore comprise at least one step to consult caching files, by the quality management module (GQ) (for example by means of a cache module E), after the communication (80) of a manager's server (SG) with the quality management server (SQ). This latter server then returns the data of at least one of the caching files to permit the execution and functioning of the interactive tool whose tag has been detected by the manager's server (SG).

In some embodiments, the interactive tools (QD, WR) also comprise a link towards a “zoom” function of the quality management server (SQ). For example, FIGS. 10-13 are illustrations of interactive tools in rolled out form. This rollout form can be generated by this zoom mechanism, when an is internet user selects a specific link (for example an icon symbolizing an eye in these figures). The summary representation (RS) then contains an array comprising as many lines as there are criteria. Each line (criterion) is constructed by grouping together all the votes of same value (rating) within the scale (ECH) and sorted in decreasing order of scores. The zoom functions also enable internet users, by means of at least one link in the display surface of at least one of the values (ratings) of the scale, to consult the comments on criteria associated with the object, with respect to the criterion and value to which this link corresponds (for example, if the internet user clicks on a green part of the representation, he obtain the comments of the internet users who voted the value “fully agree” represented by this green part). When the internet user selects this link, a request (for example of “ajax” type) is transmitted to the quality management server (SQ) which sends back the comments associated with the value (rating) selected using this link, regarding the criterion under consideration for the object under consideration. Some embodiments of the method may therefore comprise steps allowing the implementation of these operating functions.

In some embodiments, the quality management server (SQ) also integrates centralized search functions. The search detailed above, notably with reference to search module G, only concerned the objects of one manager's website(s) since the tag for the search tool (WR) was generated with respect to the evaluation data (EV_G) of this manager. Centralized search allows the search for objects on all the websites (SW) of all the managers registered with the quality management server (SQ), for example if these managers have authorized the referencing of their site(s) for this centralized search. For example, in some embodiments, managers can define in their profile if they allow the sharing of data relating to their objects with at least one manager offering identical or similar objects. For example, a manager can set a “peer” sharing with another manager authorizing the same sharing, or an “open” sharing with any other manager. These shares will enable for example a manager to consolidate the data relating to his objects with votes and/or comments (text and/or image and/or video, etc.) originating from evaluation data (EV_G) associated to at least one other manager. The quality management module (GQ) is arranged to establish an association in the quality database (DB_Q) between evaluation data (EV_G) associated with identification data (ID_G) a plurality of managers. For example, the quality management module (GQ) can offer a manager who is in the process of defining an evaluation (benchmark), a list of managers (or websites of these or any type of information relevant to the Identification of managers), for example those offering items of the same category (CO) as the one selected during the evaluation, so as to enable him to select at least one manager with which he agrees to share information. The quality management module (GQ) can also be arranged to help defining what are the information for which the sharing is allowed. In addition, the quality management module (GQ) may also propose a mechanism of moderation (restraint) for managers, so as to enable them to control the information published. The quality management module (GQ), for example by means of a specific centralized search module (GC), is therefore arranged to conduct searches in all object data (O) associated with the evaluation data (EV_G) of a plurality of managers (for example at least those who authorized this centralized search of their objects). Especially in embodiments where managers can define a shared “open”, it is possible to make available the content relating to objects of various managers sharing their information from a neutral zone (independent from the website of managers, such as a website accessible via the quality management server (SQ) for example). This neutral zone also allows collecting information, such as votes of the users who performed a search. Managers may also have defined that they allows having these information published on their website (SW), with or without moderation (in the sense of an intervention by the manager to control content). Through this type of centralized search, the internet users can select links to be redirected to the websites of managers and place their votes and/or comments. In some embodiments, the quality management module (GQ) will be arranged to collect the votes and/or comments is submitted in response to a centralized research in order to update data relating to objects that are accessible via this centralized search. For implementing the centralized search, a web page with search criteria, for example the quality criteria, is transmitted for example to an internet user's communication terminal I2, (FIG. 1) who has selected a link for a centralized search. The internet user selects the desired criteria and validation permits a search in all the objects (and notably with all the quality criteria) of the database, and the sending back of the list of objects of the various managers, optionally with the links to the website(s) (SW) of the managers offering these objects. The centralized search may also permit a search in the various types of data associated to the evaluation data of the various managers, such as for example all the object voting calculation data (OVC). In some embodiments, this centralized search can also be implemented via at least one interactive tool.

At least some of the advantageous mechanisms used in the present invention for management of quality criteria can be used for the management of technical criterion data (CT), representing of the technical features of objects. Indeed, at least some information on technical characteristics of objects are generally made available to users by managers by putting theses information online on their website (SW), for example in a thumbnail or tab of a webpage (PW) comprising an object or through a link to this information. This provision is often mandatory for managers. The invention facilitates the provision at least for part of managers thanks to the technical criteria data (CT) which will be associated with categories (CO) of objects in the quality database (DB_Q). A manager who conducts an evaluation of an object can therefore create technical criteria or reuse technical criteria already set by other managers, rather than entering them himself. Furthermore, mechanisms for sorting/selecting the quality criteria (CQ_O) can also be implemented for these technical criteria (CT) in order to converge to lists of technical criteria which are the most relevant possible. Note that the technical criteria data (CT) may, in a manner known per se, have at least two types of information: the technical characteristic and an actual value of the object for is this technical characteristic (for example, the characteristic “resolution” of a screen may have a value of “600×800”). The mechanisms of collective intelligence (collaborative definition) proposed in the present invention can be used on both types of information. Moreover, in some embodiments, internet users can also collaborate in the management of technical criteria, for example through links enabling them to report an error and/or enter a technical criterion or its value. In some particularly advantageous embodiments, the collection of technical criteria and/or their values can be implemented using interactive tools described in this application. For example, when a manager incorporates a tag (Tag_Q) for an interactive tool in a page of its website, it can be provided that the manager can specify the location of data representing the technical characteristics (and values) of the object in the web page (e.g., by at least one tag or address (url) of a page or thumbnail or tab, etc.). Thus, when the interactive tool (QD) is executed and consults or creates the object data (O) in the quality database (DB_Q), it will also collect data on technical characteristics (and their values) of the object to transmit them to the quality management module (GQ), for example by copying the contents of the thumbnail or tab containing this information. An automatic mechanism of discrimination between the technical criteria and values of these criteria can be implemented. For example, an analysis module with a list of technical criteria compares the data transmitted by the interactive tool to this list so as to recognize the information relating to the criteria from those relating to the value of the criteria. For some objects, such discrimination can be achieved by the recognition that the information about the values contain a majority of numbers while those on the technical criteria include a majority of letters. Another possibility is to simply collect data and then propose them to managers who, instead of having to enter, simply select them. This already present an advantage for managers and permit to benefit from their participation in defining the technical criteria. Furthermore, using a number of use for these technical criteria (CT) in the same manner as the number (N) use of quality criteria (CQ_O), the participation of managers will converge to the technical criteria which are the most relevant, eliminating errors, or fantasies, while having already facilitated the task for managers. These embodiments allow extending the collaborative development of the database to information relating to technical characteristics of objects. This provides a database containing the technical criteria for all categories (CO), and the possible values of these criteria.

In some embodiments, the Quality Management module (GQ) is also arranged to manage data related to users themselves. For example, users can define a profile and/or nickname and/or an avatar, etc. In some advantageous embodiments, users may also define their membership to at least one type of “public” (in the sense of “people” or “audience”), that is to say at least one category of users of the objects. For example, a user can be defined as belonging to a “young”-type public, but also as belonging to a “confirmed photographer-type public, etc. Some definitions may be performed automatically by the management module (GQ) from certain information supplied by the user (e.g., age entered by the user allows defining, or at least asking to confirm, that the users belongs to “young” or “Senior” type of public, or the entry of a number of children allows to define a membership of a “large family” type public). In the quality database (DB_Q), this definition is permitted by public data (DP), representing categories of users (groups of users). The creation of these data will be managed by the quality management server (SQ) in the same way as for the quality criteria data (CQ_O), that is to say with at least part of the mechanisms described in this application in reference quality criteria data (CQ_O). Moreover, in these embodiments managing such public data (DP), the managers can also define the types of public (audience) they believe interested in each category (CO) of objects for which they make an evaluation. Thus, when a manager registers an evaluation of an object, he can select the public type(s) for which the object is intended. The public data (DP), in particular information concerning the categories of users, can be managed in the same way as quality criteria, with the distinction of criteria (Cpub) already used by several of those managers from those (Cpriv) used only by one manager. For this definition, the manager may select a link “public concerned” for obtaining a form comprising at least one list representing the data (DP) of publics listed in the database. The selection (or entry) of at least one type of public by the manager then allows the quality management module (GQ) to associate the category (CO) of an object (O) to the type(s) of public chosen by manager. In the quality database (DB_Q), each category (OC) of object can be associated with at least one type of public, among the public data (DP). The categories of objects are then associated with the types of public (ie, categories of users) who may be interested in these objects. Thus, when an internet user performs a search (such as a centralized search described in this application) in a category of objects to which none of the public types of this Internet user are associated, the management module (GQ) is arranged to propose the internet user to select at least one public type among those associated with the selected category. If the selected category is already associated with one public type that is defined in the profile of the user, the management module may also propose this public type and possibly highlight it (for example by the preselecting it in the proposed list, while leaving the possibility to deselect it). The selection (and validation) of a type of public by the Internet user allows the automatic updating of user profile in certain embodiments.

The mechanisms used for the quality criteria can be used by the quality management module (GQ) to present to the manager a list of publics already registered by other managers and/or to propose to enter a new type of public and/or to enable him to get a list of recent public types. The presentation of the public types already registered may use a mechanism for sorting (classifying) based on the number of use of public types in a given category, in the same way as for the quality criteria (CQ_O). The public data (DP) may therefore include a counter for counting the number to use, for example for each category (CO) of object where the type of public (user category) was selected. In addition, for each criterion used by managers for the evaluation of objects (quality criterion (CQ_O) and/or technical criterion (CT) in particular), associated with a given category, the manager can define a value representative of the adequacy of this criterion to each public type associated to this category (for example through a discrete value among a scale of values, as for the rating of objects for each quality criteria (CQ_O) as described in this application). Indeed, by associating one type of public to at least one category (or at least one category to at least one type of public), the type of public selected by the manager is indirectly associated with at least one criterion (a quality criterion (CQ_O) for example) associated with the category (CO). When a manager selects an association between a category (CO) and a public type, the Quality Management module (GQ) will retrieve all the criteria associated with this category and present them to the manager. Then, for each criterion, the manager can then select at least one value (rating) which should have been attributed to the object so that it is interesting for the selected public type. For example, a manager who recorded an evaluation in a category “Kitesurf wing”, and who have selected or defined a public type “beginner rider”, will be able to define that this public type should be associated with objects for which a quality criterion “easy re-take-off” has a value (rating) rather favourable (that is to say a high rating in the scale of value). This definition of the value may use a minimum value, a maximum value or a range of values. Thus, users belonging to the public “beginner rider” will direct obtain searches for kite wings with which is it easy to take-off again as stated by other users (thanks to the use of object voting calculation data (OVC) defined during the votes of users on the quality criteria of objects for example). This definition allows that the internet users search for objects in a very intuitive manner, based on their membership to at least one type of specific public (i.e., a given category of users), set in their profile and/or during their search. By simply selecting the types of public which they believe to belong to, users can easily obtain a search using a plurality of specific criteria (quality criteria and/or technical criteria) while they simply defined a type of public (a group of users) which they believe to belong to. The quality management module (GQ) will be arranged in some embodiments to allow searches in which at least part of the search criteria correspond to at least part of the public data (DP) (and their association(s) to other data of the quality database). Such research allows for example to avoid that the Internet users have to classify criteria, described herein for the quality criteria (CQ_O), when searching or allows to pre-select criteria in order to propose the Internet users to classify them.

It is therefore understood that the present invention is particularly advantageous for managing data relating to objects in general. It is especially advantageous for information relating to the quality of objects, but also for information on technical characteristics of objects or relating to users. In general, the mechanisms described in this application may be implemented for various types of information where they will provide the benefits described herein.

It will therefore be appreciated that various embodiments of the invention permit in particular:
Formulation of the issue (problematic) of quality in terms of criteria, notably criteria comprising a short name and an assertion.
The progressive validation (or elimination) of criteria for the collaboration of managers.
The valuing of each criterion by voting internet users, with a scale of discrete values.
Representation of the votes on interactive tools deployed on managers' sites, notably tools comprising an array in which the criteria are sorted as per decreasing positive consensus (average score).
A mechanism ensuring the availability of interactive tools and of the data required for implementing the invention, even in the event of major failure on the servers (the database in particular).
The possibility provided to formulate a qualitative search by specifying the internet user's priority criteria.

It will be apparent to the person skilled in the art, on reading the present application, that the present invention allows embodiments in is numerous other specific forms without departing from the area of application of the invention as claimed. Therefore, the present embodiments are to be construed as illustrations which can be modified in the area defined by the scope of the appended claims, and the invention is not to be limited to the details set forth above.

1. A quality management server for the management of data relating to objects, the quality management server being accessible, via at least one communication network, to at least one manager of at least one website hosted on at least one server for offering objects to Internet users having access to said network via a navigator executed on their communication terminal, the quality management server comprising a data processing arrangement for executing at least one quality management module for managing at least one quality database and for memorizing category data, representing a plurality of categories of objects, the quality management module being arranged to control defining and gathering object quality data by interacting with managers of websites connected to the quality management server by of a terminal for communicating across said network, by controlling the recording in the quality database:
evaluation data representing at least one evaluation of the quality of at least one object offered on the manager's website, the evaluation data permitting referencing of said object by the manager in at least one object category of the quality database through an association of this the evaluation data with the category data of the quality database by the quality management module, and
quality criteria data representing at least one evaluation criterion for the quality of said object and the number of uses of this the criterion by the managers, the quality criteria data being associated with the evaluation data, the quality management module being arranged to record the quality criteria data in response to remote triggering by a manager, either in response to (a) entry of a new quality criterion, or (b) selection of a quality criterion from among a list of criteria already entered by at least one manager in the quality database.

2. Quality management server according to claim 1, the quality management module arranged to sort the quality criteria for a given object category in relation to the number of their uses by managers, and to present managers with this list of sorted criteria to cause convergence of used criteria towards the most consensual criteria.

3. Quality management server according to claim 1, the management module arranged to identify managers registered with the quality management server in response to identification data representing at least one identifier of a manager, stored in the quality database.

4. Quality management server according to claim 3, the management module arranged to save the evaluation data, representing at least one evaluation of the quality of at least one object the quality in association with the identification data.

5. Quality management server according to claim 1, the quality management module arranged to generate, in the database, data representing at least an association between quality criterion data and at least part of the manager's identification data and/or evaluation data.

6. Quality management server according to claim 5, the quality management module arranged, before generating quality criteria data in the quality database, to verify the existence of an identical or similar criterion to the one entered by the manager, and if similarity is detected to propose a choice to the manager from among the entered criterion and the other similar criteria.

7. Quality management server according to claim 1, the quality management module arranged to record the quality criteria data in the quality database in response to triggering by the manager is managed by controlling the creation, in the quality database, of data representing a criterion, associated with the manager's evaluation data.

8. Quality management server according to claim 7, wherein, upon the creation of data representing a private criterion, when a second manager selects, as an evaluation criterion, a private criterion introduced by a first manager, the quality management module is arranged to control the creation, in the quality database, of data representing a public criterion associated with the category in which the object being evaluated is referenced, the quality management module being arranged to then eventually increment, in the quality database, the number of uses of the public criterion, and create data representing (a) a private criterion associated with the evaluation data of the second manager who uses this criterion for the first time, and (b) an association between the public criterion and the private criteria in the identification data of the two managers to associate the managers with the public criterion in the quality database.

9. Quality management server according to claim 7, wherein, upon the creation of data representing a private criterion in response to a third manager selecting, as an evaluation criterion, a public criterion already used by other managers, the quality management module is arranged to (a) control the creation of data representing an association between the public criterion and the private criteria in the identification data of the two managers to associate the managers with the public criterion in the quality database and (b) increment, in the quality database, the number of uses of the public criterion.

10. Quality management server according to claim 1, the quality management module arranged to collaborate, for management of quality data, between Internet users accessing at least one of the websites of a manager, by generating and transmitting to the manager at least one tag, integrated by the manager in the source code of at least one web page of his website so that, in response to the navigator of an Internet user's communication terminal requesting access to this web page, the manager's server arranged to use the tag directed towards the quality management module, to obtain from the latter and to integrate in the data of the web page transmitted to this navigator, the data that are necessary for the execution and functioning of the interactive tool in the navigator, the interactive tool being arranged for forming a graphical interaction interface for the internet user directly with the quality management module by using at least one link displayed on the interface which can be selected by the Internet user and is directed towards at least one function of the quality management module.

11. Quality management server according to claim 10, the interactive tools comprise at least one interactive voting tool, the quality management module being arranged to generate the tag for the tool for each of the evaluation data created by a manager, the integration of the tag in the source code of at least one page of the manager's website allowing the defining of object data representing the evaluated object to be defined, the quality management module contacted by the manager's server hosting the page at the time of access by a communication terminal to the page, being arranged firstly to consult the quality database, so as to extract therefrom or to create therein, if such do not already exist, object data representing the evaluated object and to extract, if such exist, object voting calculation data associated with the object data and representing the number of times each of the values (ratings) from among a determined scale of values has been selected by Internet users for each of the criteria available for the object, and secondly to determine and transmit to the interactive tool, on the basis of the object voting calculation data, at least one summary representation of Internet user votes for each criterion available for the object or a prompt message for inviting the Internet user to be the first to vote if these object voting calculation data do not exist in the quality database, the interactive voting tool being arranged for displaying on the communication terminal firstly information on the object in response to the object data and secondly this summary representation or this prompt message.

12. Quality management server according to claim 11, the interactive voting tool arranged to display a voting link which (a) can be selected by Internet users on their communication terminal and (b) is directed towards the quality management module arranged to send this terminal a voting form when this link is selected, Internet user's terminal being arranged to display the form that includes (a) a selection or entry field for enabling the Internet user to allocate a value (rating) from among a scale of values proposed in the form, to each of the criteria available for the object with which the interactive voting tool is associated, and (b) at least one validation field which can be selected to send the completed form to the quality management module arranged to retrieve the form and, on the basis of its data, to create in the quality database, at least criteria voting data representing the value (rating) allocated by the Internet user to the object for each criterion from among a scale of values proposed in the form and to create, if such do not already exist, or to update object voting calculation data in the quality database on the basis of this criteria voting data.

13. Quality management server according to claim 10, the interactive tools comprise at least one interactive search tool, the quality management module being arranged to generate the tag for the tool for each of the identification data created by a manager, the integration of the tag in the source code of at least one page of the manager's website allowing access of the search tool to the manager's identification data and/or evaluation data, the quality management module contacted by the manager's server hosting the page at the time of access by a communication terminal being arranged (a) to consult the quality database to extract the category data and criteria data associated with the manager's evaluation data, and (b) to send the search tool a search form including selection and/or entry fields enabling Internet users to select at least one category in which it is desired to conduct an object search and, for each category, to select at least one choice of criterion or choice of order of priority of a plurality of criteria, the form including a validation field for sending the form via the interactive search tool to the quality management module arranged to retrieve this selection in the form and to search, in the quality database on the manager's website for the object data which correspond to this criteria selection.

14. Quality management server according to claim 10, the quality management module arranged to (a) search in the quality database for object data associated with the criteria selected by the Internet user in the search form and the object voting calculation data associated with the object data, and (b), in response to the Internet user's selection including an order of priority of a plurality of criteria, sorting the objects found in relation to a classification score allocated to each of the criteria available for each of the objects and calculated on the basis of the value (rating) of these criteria in the object voting calculation data applying a coefficient to each criterion in relation to its classification in the order of priority, then to send back a page with the result of this search and of this sorting to the search tool, for display on the Internet user's communication terminal.

15. System for the management of data on the quality of objects, via at least one communication network, comprising at least one server of a manager of at least one website for offering objects to Internet users having access to said communication network via a navigator executed on their communication terminals, the system comprising at least one communication terminal of at least one manager of a website and at least one quality management server according to claim 1.

16. System according to claim 15, further comprising at least one communication terminal of at least one internet user and at least one quality management server, the quality management server being accessible, via at least one communication network, to at least one manager of at least one website hosted on at least one server for offering objects to Internet users having access to said network via a navigator executed on their communication terminal, the quality management server comprising data processing arrangement for executing at least one quality management module managing at least one quality database and for memorizing category data, representing a plurality of categories of objects, the quality management module being arranged to control the defining and gathering of object quality data by interacting with managers of websites connected to the quality management server by a terminal communicating across said network, by controlling the recording in the quality database:
evaluation data representing at least one evaluation of the quality of at least one object offered on the manager's website, the evaluation data permitting the referencing of said object by the manager in at least one object category of the quality database through an association of this the evaluation data with the category data of the quality database by the quality management module, and
quality criteria data representing at least one evaluation criterion for the quality of said object and the number of uses of this the criterion by the managers, the quality criteria data being associated with the evaluation data, the quality management module being arranged to record the quality criteria data in response to remote triggering by a manager, either in response to (a) the entry of a new quality criterion, or (b) selection of a quality criterion from among a list of criteria already entered by at least one manager in the quality database,
the quality management module arranged to collaborate, for management of quality data, between Internet users accessing at least one of the websites of a manager, by generating and transmitting to the manager at least one tag, integrated by the manager in the source code of at least one web page of his website so that, when the navigator of an internet user's communication terminal requests access to this web page, the manager's server arranged to use the tag directed towards the quality management module, to obtain from the latter and to integrate in the data of the web page transmitted to this navigator, the data that are necessary for the execution and functioning of the interactive tool in the navigator, the interactive tool forming a graphical interaction interface for the internet user directly with the quality management module by using at least one link displayed on the interface which can be selected by the Internet user and is directed towards at least one function of the quality management module.

17. Interactive tool for collaboration between Internet users in the management of data on object quality, across at least one communication network, the interactive tool being arranged to be executed in the navigator of at least one communication terminal of at least one Internet user, the interactive tool being arranged to form a graphical interaction interface for an Internet user directly with the quality management module of a management server according to claim 1, by at least one link arranged to be displayed on this interface, the link being selectable by the Internet user and directed towards at least one function of the quality management module.

18. Interactive tool according to claim 17, the tool arranged to be executed on the navigator of the Internet user's communication terminal by integration of at least one tag by the manager in the source code of at least one web page of his website so that, in response to the navigator of an Internet user's communication terminal requesting access to the web page, the manager's server is arranged to use the tag directed towards the quality management module to obtain from the latter and to integrate in the data of the web page transmitted to the navigator, the data necessary for execution and functioning of the interactive tool in the navigator.

19. Interactive tool according to claim 18, the tool is an interactive voting tool, arranged to present Internet users with votes relating to at least one quality criterion of an object, the quality management module being arranged to generate the tag for the interactive tool for each of the evaluation data created by a manager, the interactive tool being arranged so integration of the tag in the source code of at least one web page of the manager's website allows the defining of object data representing the evaluated object, the quality management module, contacted by the manager's server hosting the page at the time of access by a communication terminal to this page, being arranged to (a) consult the quality database to extract therefrom or to create therein, if such does not already exist, object data representing the evaluated object and to extract, if such exists, object voting calculation data associated with the object data and representing the number of times each of the values (ratings) from among a determined scale of values has been selected by Internet users for each of the criteria available for the object, and (b) to determine and transmit to the interactive tool, on the basis of object voting calculation criteria, at least one summary representation of Internet user votes for each criterion available for the object or a prompt message inviting the Internet user to be the first to vote if the object voting calculation data does not exist in the quality database, the interactive voting tool being arranged for displaying on the communication terminal firstly information about the object by means of the object data, and (b) the summary representation or this prompt message.

20. Interactive tool according to claim 19, the interactive voting tool arranged to display a voting link which can be selected by Internet users on their communication terminal and the interactive voting tool directed toward the quality management module arranged to send the terminal a voting form in response to the link being selected, the form being displayed on the Internet user's communication terminal and comprising (a) at least one selection or entry field enabling the Internet user to allocate a value (rating), from among a scale of values proposed in the form, to each of the criteria available for the object with which the interactive voting tool is associated, and (b) at least one validation field which can be selected to send the completed form to the quality management module arranged to retrieve the form and, on the basis of the data contained in the latter, to create in the quality database at least criteria voting data representing the value (rating) allocated by the Internet user to the object for each criterion from among the scale of values proposed in the form and to create, if such does not exist, or to update the object voting calculation data in the quality database on the basis the voting criteria.

21. Interactive tool according to claim 19, wherein the tool is an interactive search tool, being arranged to generate the quality management module, the tag for each of the identification data created by a manager, the integration of this tag in the source code of at least one web page of the manager's website allowing access of the search tool to the manager's identification data and/or evaluation data, the quality management module contacted by the manager's server hosting the page at the time of access by a communication terminal being arranged (a) to consult the quality database to extract the category data and criteria data associated with the manager's evaluation data, and (b) to send to the search tool a search form containing selection and/or entry fields for enabling the Internet user to select at least one category in which it is desired to conduct an object search and, for each category, to select at least one choice of criterion or choice of order of priority of a plurality of criteria, the form including a validation field for sending the form via the interactive search tool to the quality management module arranged to retrieve this selection in the form and to search in the quality database, for object data on the manager's website which correspond to the selection of criteria.

22. Interactive tool according to claim 19, wherein the tool is an interactive search tool displayed on at least one web page and comprising at least one search link directed towards a function of the quality management module for sending back to the Internet user's navigator a search form including selection and/or entry fields for enabling the Internet user to select at least one category in which it is desired to conduct an object search and, for each category, to select at least one criterion choice or a choice of order of priority of plural criteria, the form including a validation field for sending the form via the interactive search tool to the quality management module arranged to retrieve the selection in the form and to search in the quality database, for object data on the manager's website which correspond to the criteria selection.

23. Method of managing data relating to objects, on at least one quality management server, accessible via at least one communication network to at least one manager of at least one website hosted on at least one server and offering objects to Internet users accessing said network via a navigator executed on their communication terminal, the quality management server including a data processing arrangement, the method comprising causing the data processing arrangement to execute at least one quality management module managing at least one quality database and memorize data representing a plurality of categories of objects, and activating the quality management module so it manages interaction with the managers of websites connected to the quality management server by way of a terminal that communicates across said network, to control the defining and gathering of data on object quality by:
recording evaluation data in the quality database, representing at least one evaluation of the quality of at least one object offered on the manager's website, the evaluation data including data representing referencing of said object by the manager in at least one object category of objects in the quality database,
recording in the quality database quality criteria data, representing at least criterion evaluating the quality of said object and a number of uses of this criterion by the managers, the recording of quality criteria data by the quality management module being remotely triggered by a manager, either by an entry step to enter a new quality criterion, or by a selection step that selects a criterion from a list of criteria already recorded by at least one manager in the quality database.

24. Method according to claim 23, wherein the recording of quality criteria data, if criteria already exist in the quality database for the object category selected by the manager, is preceded by sorting the quality criteria associated with the category, to sort the criteria in relation to the number of their uses by managers, the method further comprising displaying the list of sorted criteria, to cause converging of used criteria towards the most consensual criteria.

25. Method according to claim 23, further comprising identifying managers registered with the quality management server, by using identification data representing at least one identifier of a manager, stored in the quality database.

26. Method according to claim 25, wherein the recording, by the quality management module of evaluation data representing at least one evaluation of the quality of at least one object, being accompanied by recording data representing an association of this evaluation data with the manager's identification data.

27. Method according to claim 23 wherein, in response to criteria being entered by a manager, the quality management module creates data representing at least an association of quality criteria data with at least part of the manager's identification data and/or evaluation data.

28. Method according to claim 27, wherein the quality management module, before the creation of quality criteria data in the quality database, performs at least one verification that verifies the existence of an identical or similar criterion to the one entered by the manager, and if similarity is detected, the module proposes a choice to the manager from among the entered criterion and the other similar criteria.

29. Method according to claim 27, wherein the creation of data relating to quality criteria in the quality database, by the quality management module comprises at least one of the following:
creating data representing a private criterion,
associating data representing the private criterion with the manager's evaluation data.

30. Method according to claim 29, wherein, at the creation of data representing a private criterion, in response to a second manager selecting, as an evaluation criterion, a private criterion introduced by a first manager, the quality management module creates (a) data representing a public criterion, and associates this public criterion with the category in which the object being evaluated is referenced, and (b) data representing an association between the public criterion and the private criteria in the identification data of the two managers, to associate the managers with the public criterion in the quality database and an eventual incrementing of the number of uses of the public criterion.

31. Method according to claim 29, wherein the quality management module responds to the creation of data representing a private criterion, by a third manager selecting, as an evaluation criterion, a public criterion already used by other managers, by (a) creating data representing an association between the public criterion and the private criteria in the identification data of the two managers, to associate the managers with the public criterion in the quality database and (b) incrementing of the number of uses of the public criterion.

32. Method according to claim 23, further comprising causing the quality management module to create at least one tag, to allow collaboration between Internet users accessing at least one website of a manager, followed by at least one tag integration by the manager of the website in the source code of at least one web page of his website so that, during an access by the navigator of an Internet user's communication terminal to this web page, the manager's server uses the tag directed towards the quality management module to communicate with the latter and to obtain the data needed for execution and functioning of the interactive tool in the navigator, the manager's server then integrating this data so obtained in the data of the web page transmitted to the navigator, the interactive tool forming a graphical interaction interface for the Internet user directly with the quality management module by way of at least one link displayed on this interface which can be selected by the Internet user and directed towards at least one function of the quality management module.

33. Method according to claim 32, further comprising executing at least one interactive voting tool relating to an object, the tag for the interactive voting tool being generated causing the quality management module to generate for each of the evaluation data created by a manager, the integration of this tag in the source code of at least one web page of the manager's website allowing the defining of object data representing the evaluated object, the execution being accompanied by:
consultation/creation, by the quality management module, of object data in the quality database, the object data being consulted if it exists or created if it does not exist,
consultation, by the quality management module of object voting calculation data associated with the object data and representing the number of times each of the values (ratings) among a determined scale of values has been selected by Internet users for each of the criteria available for the object,
creation, by the quality management module, of at least one summary representation of votes by Internet users for each criterion available for the object, or of at least one prompt message inviting the Internet user to be the first to vote if object voting calculation data do not exist in the quality database,
transmission to the interactive voting tool, by the quality management module, of the summary representation and/or voting link,
display, by the quality management module of the summary representation and/or voting link.

34. Method according to claim 33, wherein the display of a voting link, during selection of this link by an Internet user, accompanied by:
transmission, by the quality management module, of a voting form prepared on the basis of the object data and quality criteria associated with the object,
selection/entry in the voting form by the Internet user, at least by allocation of a value (rating) from among a scale of values proposed in the form, to each of the criteria available for the object with which the interactive voting tool is associated,
transmission of the completed voting form with the value (rating) allocated to each criterion,
recording, by the quality management module, by recording criteria voting data representing the value (rating) allocated by the Internet user to the object for each criterion from among the scale of values proposed in the form,
creation/updating, by the quality management module, of object voting calculation data in the quality database, using this criteria voting data.

35. Method according to claim 32, further including performing at least one execution of at least one interactive search tool, to generate the tag for the search tool by causing the quality management module for each of the evaluation data created by a manager, the integrating the search tag in the source code of at least one web page of the manager's website to allow the defining of object data representing the evaluated object, the execution being accompanied by:
consultation, by the quality management module, of evaluation data and criteria data in the quality database,
transmission to the interactive voting tool, by the quality management module, of a search form including the criteria available for the site from which it is executed,
display of the search form on the Internet user's communication terminal,
selection/classification of at least one criterion by the Internet user,
transmission of the completed search form to the quality management module by the interactive voting tool,
consultation of the object data and object voting data in the quality database, in relation to the completed search form,
sorting the objects in relation to object voting calculation data, in accordance with the completed search form,
transmission of the data resulting from the sorting of the objects, by the quality management module to the interactive search tool, and
display of the result of sorting of the objects, by the interactive search tool.
